(19) United States
(12) Patent Application Publication
(10) Pub. No.: US 2015/0317445 A1
(43) Pub. Date: Nov. 5, 2015

(54) MOBILE-ENABLED HEALTH SYSTEM

(71) Applicant: KINSA, INC., New York, NY (US)

(72) Inventors: Inder SINGH, New York, NY (US); Edo SEGAL, New York, NY (US)

(21) Appl. No.: 14/648,573

(22) PCT Filed: Nov. 30, 2013
(86) PCT No.: PCT/US13/72529

§ 371 Date: May 29, 2015

Related U.S. Application Data
(63) Continuation of application No. 14/093,442, filed on Nov. 30, 2013, now abandoned.
(60) Provisional application No. 61/812,648, filed on Apr. 16, 2013.
(60) Provisional application No. 61/732,066, filed on Nov. 30, 2012.

(51) Int. Cl. G06F 19/00

(52) U.S. Cl. CPC G06F 19/3406; G06F 19/3418; G06F 19/3493

(57) ABSTRACT

A mobile-enabled health system is provided having a medical device subsystem, having a medical device, such as a thermometer, operatively connected to a computing device running a first application that operates to receive health care data from a user of the medical device subsystem; a data repository configured to receive health care data from the computing device and the first application, receive health care data from third-party sources, and aggregate and analyze the health care data into contextualized health care data; and a second application operative to receive the contextualized health care data.

### CROSS-REFERENCE TO RELATED APPLICATIONS

This utility patent application claims priority from:
(1) U.S. provisional patent application Ser. No. 61/732,066, filed 2012 Nov. 30, entitled “MOBILE-ENABLED BIOSURVEILLANCE” in the name of Inder Singh and Edo Segal and
(2) U.S. provisional patent application Ser. No. 61/812,648, filed 2013 Apr. 16, entitled “MOBILE-ENABLED HEALTH SYSTEM” in the name of Inder Singh and Edo Segal.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. Copyright 2012-2013 Kinsa Inc.

### BACKGROUND OF THE INVENTION

1. Field of the Invention

Generally, the invention relates to health care.

More specifically, the invention relates to health care data collected via mobile computing devices, aggregated, and analyzed for action.

Even more specifically, the invention relates to a mobile-enabled health system for tracking and monitoring the spread of febrile and related illnesses.

2. Background

When doctors have little knowledge about which illnesses are going around a particular geographic area or group, their diagnoses suffer. Also, individuals, including parents, may not react as quickly to get care for patients (such as children) and lack the information needed to promptly take preventive action.

For example, the global SARS outbreak of 2002-2003 spread to more than 30 countries within weeks, killed thousands of people with a 10% fatality rate, and cost tens of billions of dollars in economic loss. The swine flu outbreak of 2009 had a global infection rate of 11-21%, but hundreds of millions of people did not die, because the swine flu was much less virulent than experts predicted. (Source: World Health Organization, Asian Development Bank, CIDRAP, Brookings Institute, BBC.) In both cases, quarantines were issued, but these were far too late, and fundamentally missing was real-time geo-located data related to each outbreak.

With the continued proliferation of mobile computing devices (e.g., smartphones, personal digital assistants (PDAs), etc.), many individuals have become increasingly reliant on such devices in order to perform routine activities. For example, many mobile computing device users perform multiple communication tasks (phone calls, emails, text messaging, etc.), shopping tasks (price comparisons, ecommerce transactions, etc.), and entertainment tasks (media watching/listening) with their mobile computing devices.

Various peripherals/accessories exist that connect to and/or interface with mobile computing devices in order to provide such devices with additional functionality. However, such accessories are often fairly expensive, owing to (a) the considerable engineering efforts required in order to develop them, (b) the considerable cost of their materials/manufacture, and (c) licensing fees that certain mobile computing device manufacturers demand in order to certify such peripherals as being compatible with a particular mobile computing device.

It is with respect to these and other considerations that the disclosure made herein is presented.

### DESCRIPTION OF PRIOR ART

Reports on illness often lag the rate of disease spread by weeks. This is so because, traditionally, public health officials have been willing to compromise on the immediacy of results, preferring strong signals even if they are slow and lag the spread of disease. Health care data must be certified and tested, and are often limited to sources such as trusted labs or the laboratory reporting network (LRN). For example, the most widely and best tracked infectious disease today is influenza (AKA the flu), and it is monitored by the current gold standard for outbreak tracking: provider-initiated reporting. Each year, local, state, and federal (e.g. the Center for Disease Control (CDC)) health workers use provider-reporting networks to track seasonal cases of influenza, but the weekly data collection, aggregation, and analysis results in significant delays. (By design, influenza surveillance data collection occurs on a weekly basis with a built-in lag for aggregation and analysis. The CDC uses viral surveillance, outpatient illness surveillance, mortality surveillance, influenza-associated pediatric mortality surveillance, and a summary of the geographic spread of influenza in order to better understand the movement of influenza during the traditional flu season.)

Some experimental methods attempt to predict the onset and spread of disease through the mining of various social networking data (e.g., Twitter) for disease-related terms. (See: Ginsberg J, Mohebbi M H, Patel R S, Brammer L, Smolinski M S, Brilliant L.; “Detecting Influenza Epidemics Using Search Engine Query Data,” Nature 2009; 457:1012-4.) However, such efforts suffer from low SNR (signal-to-noise ratio) due to errors in natural language processing and other limitations. To date, no approach has replaced or surpassed provider-initiated reporting.

In addition, some patent applicants have attempted to solve some of these problems.

United States Patent Application US20080200774 “Wearable Mini-size Intelligent Healthcare System” (Luo 2008 Aug. 21) discloses, in the Abstract, “A system and method for the wearable mini-size intelligent healthcare system, comprising one or multiple vital signal sensors, activity sensors, a real-time detection and analyzing module for continuous health monitoring, adjustable user setting mode with the adaptive optimization, data-collecting capability to record important health information, smart audio outputs of audio beep and speech advice to the user through audio path and audio interface, preset and user confirmable alarm conditions via wireless communications network to the appropriate individual for prompt and necessary assistance. The system uses noninvasive monitoring technology for continuous, painless and bloodless health state monitoring. The system also works through the short range RF link with carry-on PDA or cell phone for displaying health information, making urgent contact to support center, doctor or individual, or for information transmission with a healthcare center.” Luo describes a wearable device to measure and analyze various vital signs and activity sensors on a continuous basis in realtime for an individual patient. Luo describes its primary value as comprehensive monitoring of an individual patient, especially one with a chronic condition. Temperature is one of many measurements that the device monitors. Luo does not, however, provide real-time understanding of the health of a population or group.

United States Patent Application US20120244886 “Method And Apparatus For Tracking And Disseminating Health Information Via Mobile Channels” (Blom 2012 Sep. 27) discloses, in the Abstract, “An approach is provided for tracking and disseminating health information. Health information corresponding to a geographic location is caused, at least in part, to be received. Location information associated with a user equipment configured to receive a message specifying content is determined. Whether the location information is encompassed by the geographic location is determined. The message is modified to present a health alert indicator by appending supplemental content to the message or by amending the content. Initiation of delivery of the modified message to the user equipment when the user equipment is in or within a predetermined range of the geographic location is caused, at least in part.” Blom's disclosure is hypothetical and says that one can receive information on health via a mobile channel, compare it to a specific geography, and send back a health alert related to that geography on a mobile channel. Blom does not appear to be related to a bona fide product or service that has been reduced to practice.

PCT Patent Application WO2013134845 “Wearable Miniature Health Monitoring System And Method” (Luo 2013 Sep. 19) discloses, in the Abstract, “The present invention provides a forehead-wearing, mini-sized intelligent health monitoring system and the corresponding methods. The system uses noninvasive monitoring technology for continuous, real-time and painless monitoring of the health status of the wearer, based on continuous detection and intelligent analyses of the physiological signals collected from the wearer. It integrates intelligent alerting and warning functions for emergency health situations with the real-time intelligent health monitoring and collection of health information, without affecting the wearer's normal life.” Luo describes a wearable device to measure and analyze various vital signs and activity sensors on a continuous basis in realtime for an individual patient. Luo describes its primary value as comprehensive monitoring of an individual patient, especially one with a chronic condition. Temperature is one of many measurements that the device monitors. Luo does not, however, provide real-time understanding of the health of a population or group.

None of the above provides a system (1) with health care data collected from patients via smartphones, (2) that includes location data (geo-located data), (3) that includes time data (past, present, and future), (4) that integrates with existing data, and (5) that allows for better actions and outcomes. What is needed, therefore, is a system that overcomes the above-mentioned limitations and that includes the features enumerated above.

### BRIEF SUMMARY OF THE INVENTION

Technologies are presented herein in support of a system, method, and apparatus for a mobile-enabled health system.

The invention provides the health community (including government entities (such as public health officials), health professionals, and families) with better biodefense and health surveillance, which includes early warning, planning, and identification of emerging illness, symptoms, and/or pathogens.

It also provides lay individuals with a better understanding of the local health situation and context—especially the spread of communicable illness—which is useful so they are empowered and informed to (a) take actions to avoid getting ill or (b) take the right actions to recover faster at the earliest signs of symptoms of an illness.

For example, the most widely and best tracked infectious disease today is influenza, which is monitored by the current gold standard for outbreak tracking: provider-initiated reporting. Each year, local, state, and federal Centers for Disease Control (CDC) health workers use provider-reporting networks to track seasonal cases of influenza. However, the data collection, aggregation, and analysis results in significant delays. The present system allows for improved tracking of influenza.

The present system enables one to know what illnesses are spreading in a local community earlier than current methods and before they affect family and friends.

Individuals are able to take actions to avoid getting sick (e.g., washing hands, drinking a bottle of orange juice, taking vitamin C, getting more rest), parents can better respond to their children's first signs of illness (e.g., go to doctors/physicians (including pediatricians) faster if a bacterial infection like strep is going around), doctors can better diagnose and care for patients (e.g., via improved understanding of local illness trends), and society has a tool it needs to track and stop the spread of illness.

Since fever is an early sign of many illnesses, both communicable illnesses like influenza, and non communicable illnesses like diarrheal disease, fever data allows us to know when someone is first feeling sick—before they've even visited the doctor. The present system allows us to collect data from an individual early during the onset of illness. For example, a five year old isn't feeling well, so his/her temperature is taken in accordance with the present system.

The thermometer described herein is described in more detail in U.S. Utility patent application Ser. No. 13/871,660 filed 2013 Apr. 26 entitled “TEMPERATURE MEASUREMENT SYSTEM AND METHOD.”

The thermometer described herein uses the power of the smartphone (or other computing device) and with itself having a minimal amount of electronics inside. There may be no batteries, processor, or LCD, which allows it to be thin, flexible, and comfortable to use, especially for children. In short, it is a better thermometer (than existing ones), because it saves fever and symptom history for an entire family (or group), and it provides and engaging visual and audio experience that makes it easier to take a child's temperature.

In one or more implementations, a child patient is complaining of a sore throat. With a few simple taps, a user can track the patient's symptoms over time and share them with a doctor. And since the child probably got sick from one of his/her friends, the parent can check the health of a group of users, for example at the child's school, to see what the level of illness is within the group and/or to see what others have, through self-reporting by others in the group or through other health devices that also connect to the system, and then make informed decisions about when to seek care or go back to school.

In one or more implementations, a user can see a private group that the user has joined with other parents from the child's class and learn, for example that several kids are sick and strep throat is going around.

The present system supports checking local health situations, even without joining a private group. For example, information may be provided in a map. Data may be combined with data from others to provide the “health weather,” which shows the contagiousness level and what illnesses or symptoms are circulating, in relationship to time (past for historical data, in real time for present data, and in the future for predicted data).

The present system allows the tracking and monitoring of the spread of febrile and related illnesses. The present system yields informational insights that are used to intervene, stop the spread of disease, and/or decrease the morbidity or mortality associated with such illnesses through early interventions. Deployment of the present system across the globe will have large-scale impact on human health. Millions of lives may be saved in a short time.

Accordingly, the present system provides information regarding illnesses going around before they affect individuals, their family, and their neighbors. This is accomplished, in part, by providing actionable data visualizations for human health, including a real-time map of human health, and visualizations other than a map that provide a snapshot of the current health situation locally. The platform, systems, and methods of the present system help parents keep children healthy, and help doctors and health systems track the spread of illness.

These and other aspects, features, and advantages are further described in the accompanying description of certain embodiments of the invention and the accompanying drawing figures and claims.

### Features and Advantages

The features/benefits of the invention are as follows:

(1) A thermometer is provided to a user. The thermometer includes an interface to a computing device (such as a smartphone). The user may be a patient or the patient's caregiver.

(2) The computing device collects health care data about the patient from the thermometer and the associated software bundled with the thermometer via a smartphone application (such as a temperature determination application).

(3) The temperature determination application sends the health care data, in real time, to a data repository. The health care data includes metadata such as location data and symptom data (such as the patient's measured temperature).

(4) The health care data is aggregated and/or correlated with existing historical health care data, location data, social network data, and/or data on the movement or behavior of populations. It is notable that the invention enlarges the scope of what has traditionally been considered health care data, so that health care data now includes any health-related data, including symptom data (such as the patient's temperature), location data, social network data, and movement/behavior data.

(5) A disease progression application and/or a health weather map application run locally (such as on a a smartphone) and/or remotely (such as on a server computer) and enable the processing, sharing, and aggregation of any/all health care data collected, such as information pertaining to fever, illness, and/or symptoms. Such information is collected and is combined with other data sources (such as CDC public health care data).

(6) The resulting insights enable public health officials and doctors; parents, educators and individuals; and others to work to prevent, anticipate, track the spread of, and/or respond to various diseases. For example, patients are encouraged to actively manage their own health and share their health care data.

For example, with the invention, pharmacies target the right audience with the appropriate products (such as Tamiflu®) at the right time.

For example, with the invention, health care data is provided to individuals by news agencies or other entities (e.g., the provider of the system through its apps), who in turn, use it to better respond to illness (e.g., if strep throat is circulating, then patients could go to the doctor; but if it's a common cold that is circulating, then they could avoid a visit to the doctor), avoid getting ill in the first place (e.g., by avoiding an area with high levels of communicable illness; washing their hands more often), or reducing the impact of an exposure to a circulating illness/pathogen (e.g., by resting, taking vitamins, or other activities that enhance immune response via chemical, biological, or psychological means).

For example, with the invention, doctors use health care data to better care for patients, because they have more powerful local trending information about the spread of symptoms, fever, and illnesses. For example, doctors have historically treated patients based on clinical and local trend information (from their own practices) as well as lab results. Doctors will sometimes treat without lab confirmation when the symptoms a patient is displaying are similar to symptoms of other patients—such as those with a confirmed diagnosis of strep—have commonly displayed in recent days.

For example, with the invention, public health officials, can identify, track and/or respond to illness before it affects a large number of people in a population.

### BRIEF DESCRIPTION OF THE DRAWINGS

In the drawings, closely related figures and items have the same number but different alphabetic suffixes. Processes, states, statuses, and databases are named for their respective functions.

FIG. 1A is a high-level diagram illustrating an exemplary configuration of a temperature measurement subsystem.

FIG. 1B is a high-level diagram illustrating an exemplary configuration of a computing device.

FIG. 1C is an illustration of an input cavity/jack of a computing device.

FIG. 2 is a schematic diagram showing a detailed internal view of a temperature-sensing probe.

FIG. 3 is a flow diagram showing a routine that illustrates a broad aspect of a method for measuring temperature.

FIG. 4 is a flow diagram showing a routine that illustrates a broad aspect of a method for calibrating a temperature measurement subsystem.

FIGS. 5-6 depict further aspects of the systems and methods described herein.

FIG. 7 a view of the architecture of the system.

FIG. 31 shows an adult user with a patient.

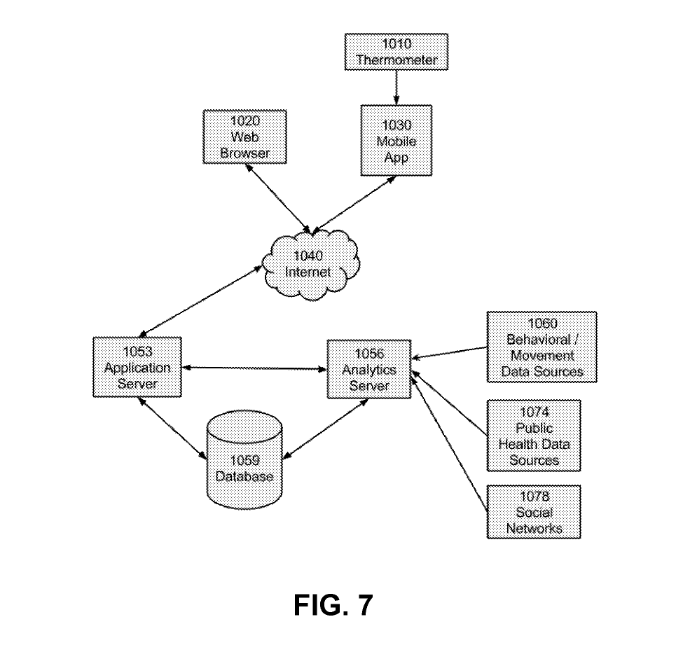

FIG. 32 shows exemplary screenshots on exemplary smartphones.

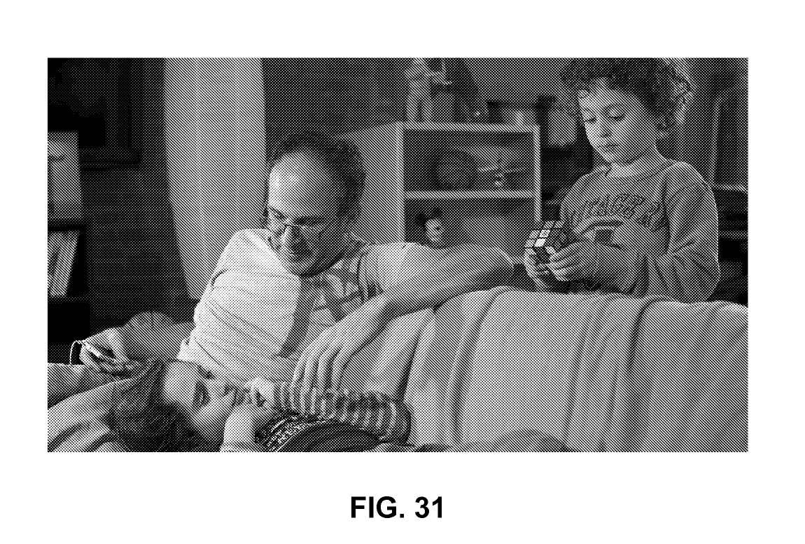

FIG. 33 shows the thermometer in and out of its product packaging.

FIG. 34 shows exemplary screenshots on exemplary smartphones.

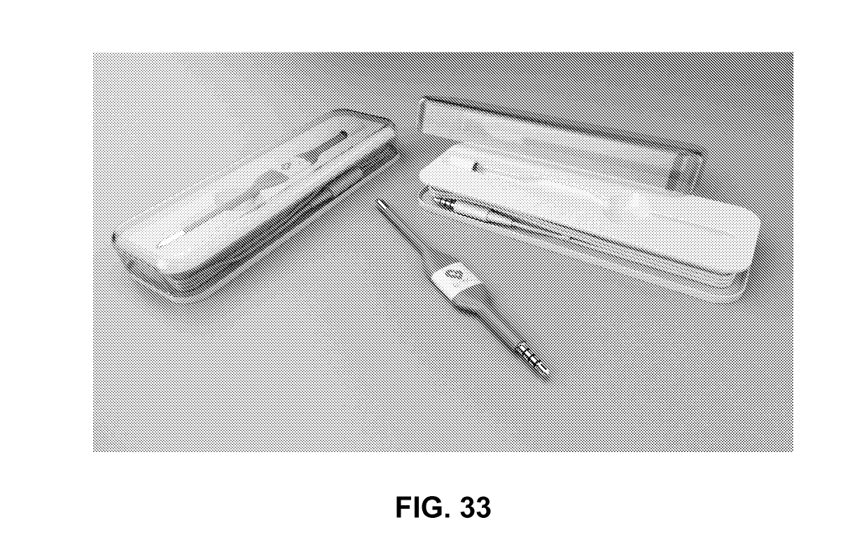

FIG. 35 shows views of the thermometer design.

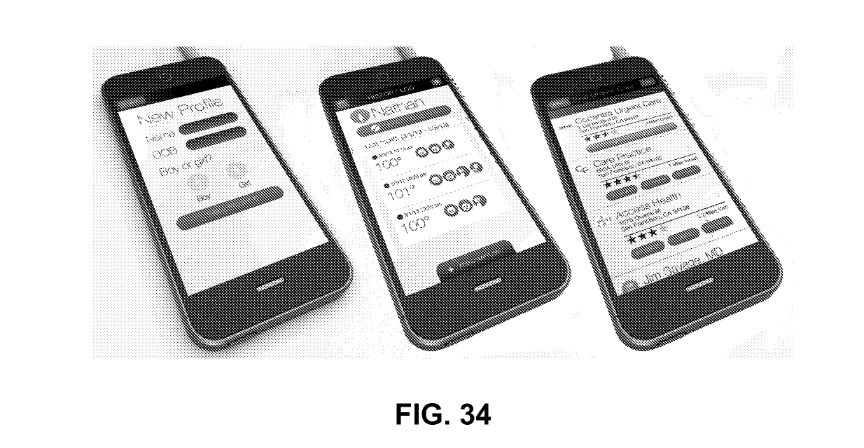

FIG. 36 shows an exemplary screenshot on an exemplary smartphone.

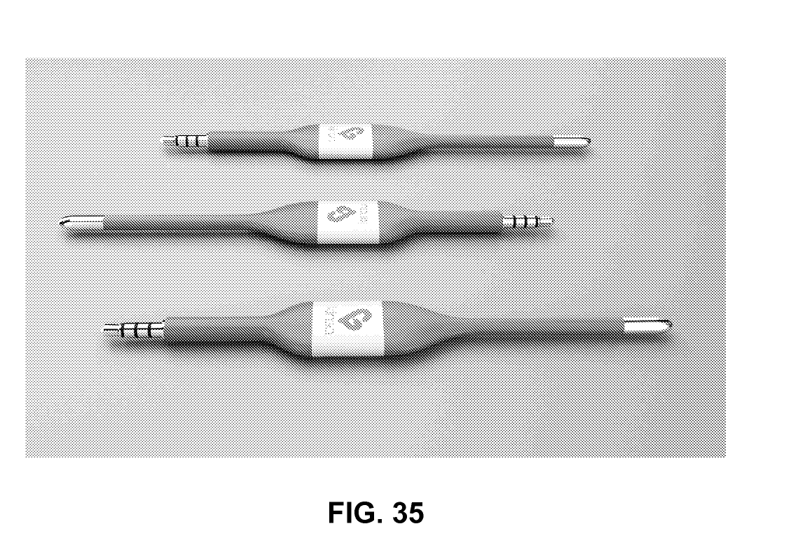

FIG. 37 shows the thermometer connected to an exemplary smartphone next to the thermometer product packaging.

FIGS. 100-200 are screenshots of the temperature determination application.

FIG. 100 is a screenshot of the “slide menu” screen.

FIG. 105 is a screenshot of a “pre temperature taking” screen.

FIG. 110 is a screenshot of a “pre temperature taking” screen.

FIG. 115 is a screenshot of the “temperature taking” screen.

FIG. 120 is a screenshot of the “post temperature reading” (before save) screen.

FIG. 125 is a screenshot of the “all symptoms” (none selected) screen.

FIG. 130 is a screenshot of the “all symptoms” (all selected) screen.

FIG. 135 is a screenshot of the “post temperature reading” (after save) screen.

FIG. 140 is a screenshot of the “save reading” screen.

FIG. 145 is a screenshot of the “family profiles—home” screen.

FIG. 150 is a screenshot of the “user profile—history log” screen.

FIG. 155 is a screenshot of the “create profile” screen.

FIG. 160 is a screenshot of the “find care” screen.

FIG. 165 is a screenshot of the “find urgent care—input” screen.

FIG. 170 is a screenshot of the “find urgent care—output” screen.

FIG. 175 is a screenshot of a “health map” screen.

FIG. 180 is a screenshot of a “health card” screen.

FIG. 185 is a screenshot of a “health map” screen.

FIG. 190 is a screenshot of a “health weather” screen.

FIG. 195 is a screenshot of a “health weather” screen.

FIG. 200 is a screenshot of the “group overview” screen.

### DETAILED DESCRIPTION OF THE INVENTION, INCLUDING THE PREFERRED EMBODIMENT

### Operation

By way of overview and introduction, various systems, methods, and apparatuses are described herein that facilitate and enable a mobile-enabled health system for tracking and monitoring the spread of febrile and related illnesses.

In the following detailed description of the invention, reference is made to the accompanying drawings which form a part hereof, and in which are shown, by way of illustration, specific embodiments in which the invention may be practiced. It is to be understood that other embodiments may be used, and structural changes may be made without departing from the scope of the present invention.

The following detailed description is directed to systems, methods, and apparatuses for a mobile-enabled health system. The referenced systems, methods, and apparatuses are now described more fully with reference to the accompanying drawings, in which one or more illustrated embodiments and/or implementations of the systems, methods, and apparatuses are shown. The systems, methods, and apparatuses are not limited in any way to the illustrated embodiments and/or implementations, as the illustrated embodiments and/or implementations described below are merely exemplary of the systems, methods, and apparatuses, which can be embodied in various forms, as appreciated by one skilled in the art. Therefore, it is to be understood that any structural and functional details disclosed herein are not to be interpreted as limiting the systems, methods, and apparatuses, but rather are provided as a representative embodiment and/or implementation for teaching one skilled in the art one or more ways to implement the systems, methods, and apparatuses. Accordingly, aspects of the present systems, methods, and apparatuses can take the form of an entirely hardware embodiment, an entirely software embodiment (including firmware, resident software, micro-code, etc.), or an embodiment combining software and hardware. One of skill in the art can appreciate that a software process can be transformed into an equivalent hardware structure, and a hardware structure can itself be transformed into an equivalent software process. Thus, the selection of a hardware implementation versus a software implementation is one of design choice and left to the implementer. Furthermore, the terms and phrases used herein are not intended to be limiting, but rather are to provide an understandable description of the systems and methods. Additionally, the system can be provided by one or more entity, but for simplicity “the provider of the system” is referred to herein.

### 1. Providing a Thermometer to a User

A medical device is provided to a user. The medical device includes an interface to a computing device (such as a smartphone) and software for the computing device to record health care data about a patient. The user may be a patient or the patent's caregiver.

As can be appreciated by a person having ordinary skill in the art, the medical device is a genus that includes many species such as a thermometer (as described in detail herein), infrared thermometer, electronic thermometer, digital thermometer, mercury thermometer, thermometer modified to additionally measure heart rate, blood pressure gauge, pulse oximeter (such as the kind that clip on to a patient's finger), heart rate measurement device, and/or other devices used to measure body or clinically relevant characteristics, or combinations of the aforementioned devices. As such, the thermometer described further below is just one example of a medical device used in the system described herein. A unique aspect of the thermometer embodiment is that it provides highly social data (data on communicable illnesses, or alternatively noncommunicable illnesses that can spread fast from a common source (such as diarrheal disease from bad water)), whereas other devices do not provide similarly highly social data. For example, individuals may care that others in their building or local area have febrile illness (as indicated by a thermometer reading) since they may also get this illness, either from others or from a similar source, whereas individuals are far less likely to care that others in their building or their local area have heart disease or high blood pressure (which is indicated in part from a blood pressure gauge) since these diseases are not communicable.

In the preferred embodiment (best mode), the thermometer subsystem has the following product specifications:

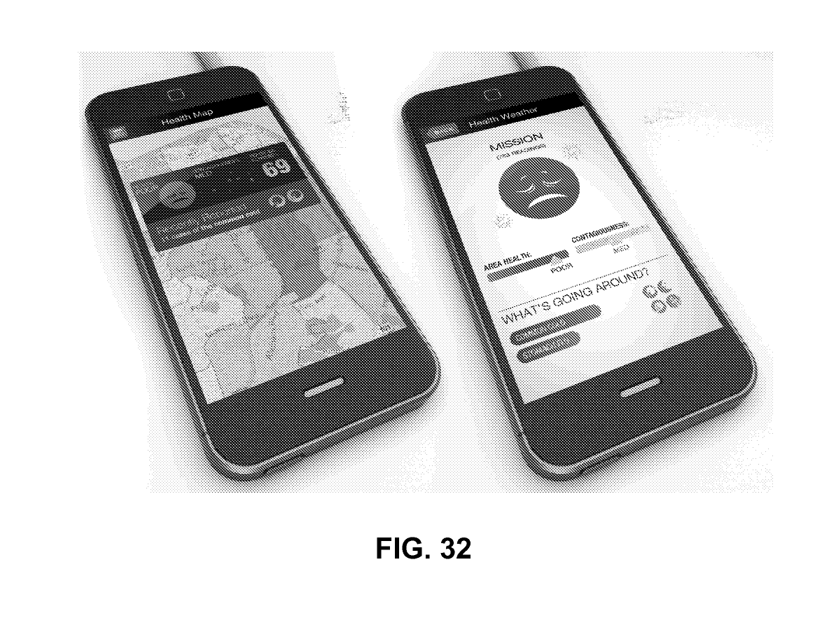

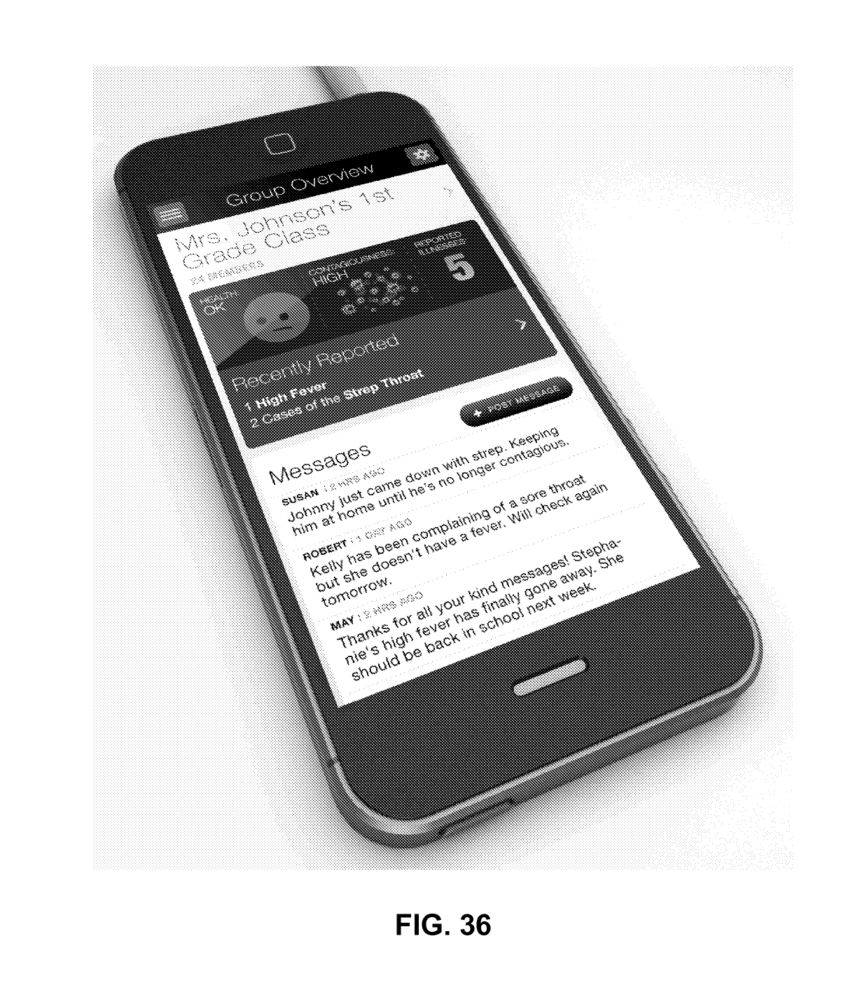

0.2 inches (H)×0.6 inches (W)×5.2 inches.
iOS and Android compatible.
Includes case and optional extension cord (see FIG. 33 and FIG. 37).
Thin and highly flexible for comfort.
No battery.
No processor.

### No LCD.

A low cost, smartphone-connected analog of a digital thermometer is provided to a user. This device, such as those described herein, for example, collects and transmits health care data (including symptom data and location data) on fever, an important and early indicator of many communicable illnesses. It also collects other symptom data and related location data (e.g., frequently visited locations) through additional technology. Using this additional technology (e.g., audio-based communication technologies and protocols to facilitate extremely low hardware-mobile computing device connectivity), price points are achieved that are a fraction of current digital thermometers, thereby enabling mass adoption.

The thermometer subsystem is further described as follows.

In the preferred embodiment, a temperature-sensing probe having a thermistor and a resistor is configured for input into the headphone jack of a computing device such as a smartphone (such as an iPhone). Signals such as audio tones are transmitted by the computing device through the headphone jack to conductors of the probe, such as a connector that is coupled to the thermistor. The various signals that are returned from the probe are used to compute a measured temperature sensed at the probe. In certain implementations, the probe is configured as an oral thermometer, though it should be understood that the systems, methods, and apparatuses described herein can be similarly configured as other types of thermometers (including, but not limited to, under-arm thermometers, forehead thermometers, ear thermometers, and rectal thermometers), as can be appreciated by those of ordinary skill in the art. In the preferred embodiment, the thermometer is bundled with an accompanying software application on the smartphone. This software operates the thermometer and provides additional software features to the user. These additional features enable the user to get more value than simply a temperature readout, as described herein, and simultaneously, and as described herein, collect more data than simply temperature/fever data. In the preferred embodiment, the thermometer is selected as the medical device, since thermometers are one of the most ubiquitous medical devices in the world, present in most households, and since thermometers are often the first device used by people in their homes to confirm common illnesses. The use of a thermometer can itself be indicative of a patient feeling ill, even if no fever is present. Additionally, thermometers are often used to monitor illnesses over the course of an illness episode or treatment course in the home. For these reasons, the smartphone-connected thermometer allows the provider of the system to begin communicating with people from the beginning of an illness episode, before they have seen or communicated with a doctor or nurse, and during the course of an illness, collecting data on fever, symptoms, illnesses and other related data.

In yet another feature, not shown here, the provider of the system bundles a symptom checker application with the software accompanying the smartphone-connected thermometer. Symptom checker functionality is included in some web or mobile software applications today, including from WebMD and PediatricSymptomMD. These features provide information to the user about the type of illness they may have based on their symptoms. In the context here, bundling this software allows the provider of the system to gather additional geo-located data about the illness or symptoms in question to enhance the mobile enabled health system described herein.

2. Collecting Health Care Data about a Patient

The thermometer, and the accompanying software application bundled with the thermometer, allows health care data to be collected about a patient. For privacy and security reasons, this health care data can be anonymized to ensure deidentification of and prevent the unauthorized access to personally identifiable information (PII) using known data obfuscation and encryption means.

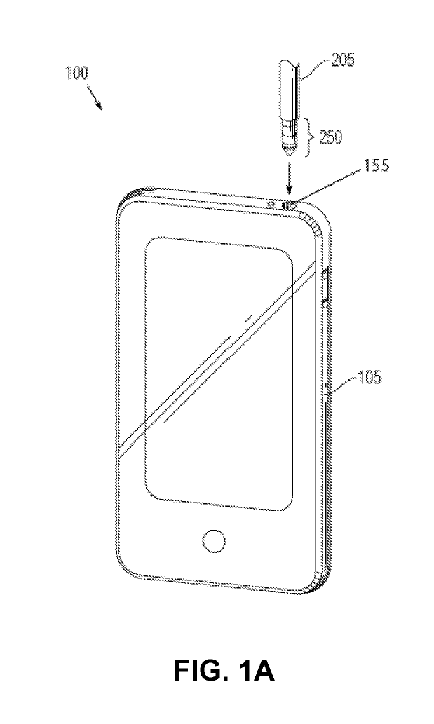

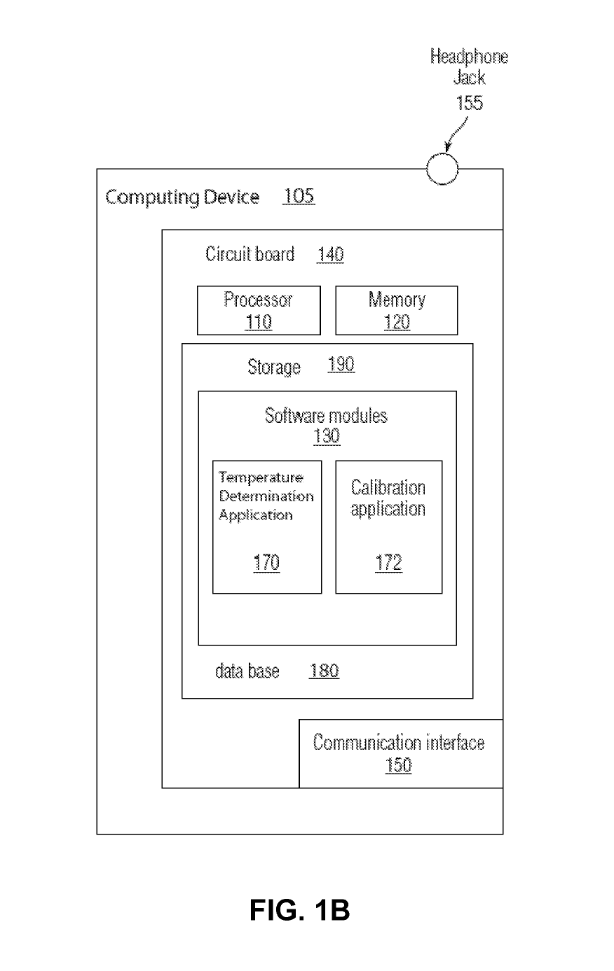

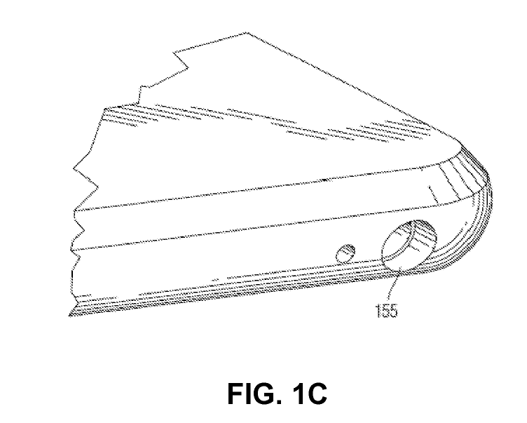

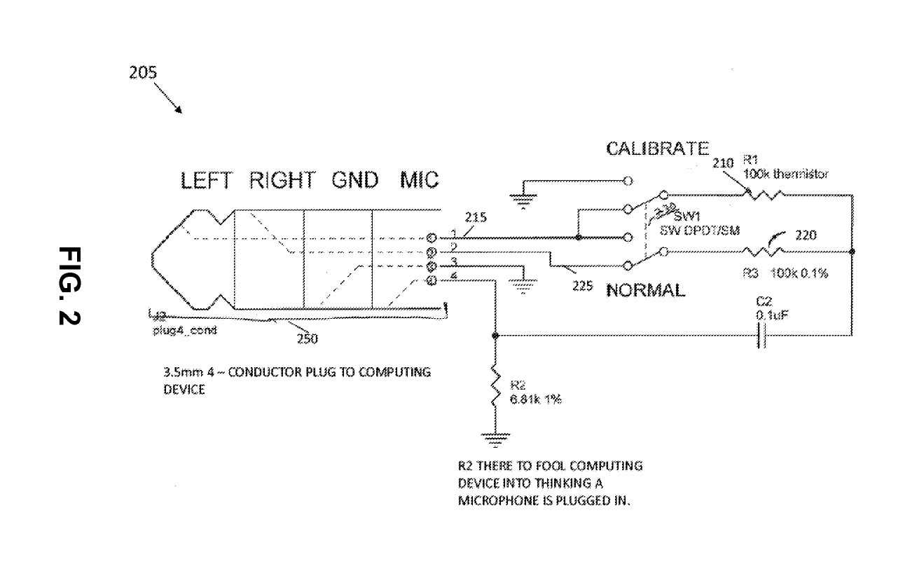

Continuing now with FIG. 1A. An exemplary temperature measurement subsystem 100 is shown in FIG. 1A. In one implementation, temperature measurement subsystem 100 includes a computing device 105, such as a smartphone or PDA. Computing device 105 will be illustrated and described in greater detail with respect to FIG. 1B. Temperature measurement subsystem 100 also preferably includes a temperature-sensing probe 205. Temperature-sensing probe 205 will be illustrated and described in greater detail with respect to FIG. 2. It should be understood, as illustrated in FIG. 1A, that temperature-sensing probe 205 includes a projecting connector/plug 250, such as a (three-contact) TRS or (four-contact) TRRS connector, as are known to those of ordinary skill in the art. Temperature-sensing probe 205 is preferably constructed such that the connector 250 is inserted into an input/output cavity 155 of computing device 105, such as a headphone jack (TRS/TRRS input), as shown in FIG. 1A and as is known to those of ordinary skill in the art. A further illustration of input cavity 155 is shown in FIG. 1C.

Turning now to FIG. 1B. A high-level diagram illustrating an exemplary configuration of computing device 105 is shown. In one implementation, computing device 105 is a personal computer or server computer. In other implementations, computing device 105 is a tablet computer, a laptop computer, or a mobile computing device/smartphone, though it should be understood that computing device 105 can be practically any computing device and/or data processing apparatus capable of embodying the systems and/or methods described herein.

Computing device 105 includes a circuit board 140, such as a motherboard, which is operatively connected to various hardware and software components that serve to enable operation of the temperature measurement subsystem 100. The circuit board 140 is operatively connected to a processor 110 and a memory 120. Processor 110 serves to execute instructions for software that are loaded into memory 120. Processor 110 can be a number of processors, a multi-processor core, or some other type of processor, depending on the particular implementation. Further, processor 110 can be implemented using a number of heterogeneous processor systems in which a main processor is present with secondary processors on a single chip. As another illustrative example, processor 110 can be a symmetric multi-processor system containing multiple processors of the same type.

Preferably, memory 120 and/or storage 190 are accessible by processor 110, thereby enabling processor 110 to receive and execute instructions stored on memory 120 and/or on storage 190. Memory 120 can be, for example, a random access memory (RAM) or any other suitable volatile or non-volatile computer readable storage medium. In addition, memory 120 can be fixed or removable. Storage 190 can take various forms, depending on the particular implementation. For example, storage 190 can contain one or more components or devices such as a hard drive, a flash memory, a rewritable optical disk, a rewritable magnetic tape, or some combination of the above. Storage 190 also can be fixed or removable.

One or more software modules 130 are encoded in storage 190 and/or in memory 120. The software modules 130 can comprise one or more software programs or applications having computer program code or a set of instructions executed in processor 110. Such computer program code or instructions for carrying out operations for aspects of the systems and methods disclosed herein can be written in any combination of one or more programming languages, including an object oriented programming language such as Java, Smalltalk, C++, Python, and JavaScript or the like and conventional procedural programming languages, such as the “C” programming language or similar programming languages. The program code can execute entirely on computing device 105, partly on computing device 105, as a stand-alone software package, partly on computing device 105 and partly on a remote computer/device, or entirely on the remote computer/device or server computer. In the latter scenario, the remote computer can be connected to computing device 105 through any type of network, including a local area network (LAN) or a wide area network (WAN), or the connection can be made to an external computer (for example, through the Internet using an Internet Service Provider).

One or more software modules 130, including program code/instructions, are located in a functional form on one or more computer readable storage devices (such as memory 120 and/or storage 190) that can be selectively removable. The software modules 130 can be loaded onto or transferred to computing device 105 for execution by processor 110. It can also be said that the program code of software modules 130 and one or more computer readable storage devices (such as memory 120 and/or storage 190) form a computer program product that can be manufactured and/or distributed in accordance with the present invention, as is known to those of ordinary skill in the art.

It should be understood that in some illustrative embodiments, one or more of software modules 130 can be downloaded over a network to storage 190 from another device or system via communication interface 150 for use within temperature measurement subsystem 100. For instance, program code stored in a computer readable storage device in a server computer can be downloaded over a network from the server computer to temperature measurement subsystem 100.

Preferably, included among the software modules 130 are a temperature determination application 170 and/or a calibration application 172, each of which can be executed by processor 110. During execution of the software modules 130, and specifically the temperature determination application 170 and/or the calibration application 172, the processor 110 configures the circuit board 140 to perform various operations relating to temperature determination/calibration with computing device 105, as will be described in greater detail below. It should be understood that while software modules 130, temperature determination application 170 and/or calibration application 172 can be embodied in any number of computer executable formats, in certain implementations software modules 130, temperature determination application 170 and/or calibration application 172 comprise one or more applications that are configured to be executed at computing device 105 in conjunction with one or more applications or ‘apps’ executing at remote devices, and/or one or more viewers such as internet browsers and/or proprietary applications. Furthermore, in certain implementations, software modules 130, temperature determination application 170 and/or calibration application 172 can be configured to execute at the request or selection of a user of another computing device (or any other such user having the ability to execute a program in relation to computing device 105, such as a network administrator), while in other implementations computing device 105 can be configured to automatically execute software modules 130, temperature determination application 170 and/or calibration application 172, without requiring an affirmative request to execute. It should also be noted that while FIG. 1B depicts memory 120 oriented on circuit board 140, in an alternate implementation, memory 120 can be operatively connected to the circuit board 140. In addition, it should be noted that other information and/or data relevant to the operation of the present systems and methods (such as database 180) can also be stored on storage 190, as will be discussed in greater detail below.

Also preferably stored on storage 190 is database 180. In certain implementations, database 180 contains and/or maintains various data items and elements that are utilized throughout the various operations of temperature measurement subsystem 100, in a manner known to those of ordinary skill in the art. It should be noted that although database 180 is depicted as being configured locally to computing device 105, in certain implementations database 180 and/or various of the data elements stored therein can be located remotely (such as on a remote device or server computer—not shown) and connected to computing device 105 through a network, in a manner known to those of ordinary skill in the art.

Communication interface 150 is also operatively connected to circuit board 140. Communication interface 150 can be any interface that enables communication between the computing device 105 and external devices, machines and/or elements. Preferably, communication interface 150 includes, but is not limited to, a modem, a Network Interface Card (NIC), an integrated network interface, a radio frequency transmitter/receiver (e.g., Bluetooth, cellular, NFC), a satellite communication transmitter/receiver, an infrared port, a USB connection, and/or any other such interfaces for connecting computing device 105 to other computing devices and/or communication networks such as private networks and the Internet. Such connections can include a wired connection or a wireless connection (e.g. using the 802.11 standard) though it should be understood that communication interface 150 can be practically any interface that enables communication to/from the circuit board 140.

At various points during the operation of temperature measurement subsystem 100, computing device 105 can communicate with one or more computing devices, such as those controlled and/or maintained by one or more individuals and/or entities. Such computing devices transmit and/or receive data to/from computing device 105, thereby preferably initiating maintaining, and/or enhancing the operation of the temperature measurement subsystem 100, in a manner known to those of ordinary skill in the art. It should be understood that such computing devices can be in direct communication with computing device 105, indirect communication with computing device 105, and/or can be communicatively coordinated with computing device 105, as is known to those of ordinary skill in the art.

In the description that follows, certain embodiments and/or implementations are described with reference to acts and symbolic representations of operations that are performed by one or more devices, such as the temperature measurement subsystem 100 of FIG. 1A. As such, it will be understood that such acts and operations, which are at times referred to as being computer-executed or computer-implemented, include the manipulation by processor 110 of electrical signals representing data in a structured form. This manipulation transforms the data and/or maintains them at locations in the memory system of the computer (such as memory 120 and/or storage 190), which reconfigures and/or otherwise alters the operation of the system in a manner understood by those skilled in the art. The data structures in which data are maintained are physical locations of the memory that have particular properties defined by the format of the data. However, while an embodiment is being described in the foregoing context, it is not meant to provide architectural limitations to the manner in which different embodiments can be implemented. The different illustrative embodiments can be implemented in a system including components in addition to or in place of those illustrated for the temperature measurement subsystem 100. Other components shown in FIGS. 1A and 1B can be varied from the illustrative examples shown. The different embodiments can be implemented using any hardware device or system capable of running program code. In another illustrative example, temperature measurement subsystem 100 can take the form of a hardware unit that has circuits that are manufactured or configured for a particular use. This type of hardware can perform operations without needing program code to be loaded into a memory from a computer readable storage device to be configured to perform the operations.

For example, computing device 105 can take the form of a circuit system, an application specific integrated circuit (ASIC), a programmable logic device, or some other suitable type of hardware configured to perform a number of operations. With a programmable logic device, the device is configured to perform the number of operations. The device can be reconfigured at a later time or can be permanently configured to perform the number of operations. Examples of programmable logic devices include, for example, a programmable logic array, programmable array logic, a field programmable logic array, a field programmable gate array, and other suitable hardware devices. With this type of implementation, software modules 130 can be omitted because the processes for the different embodiments are implemented in a hardware unit.

In still another illustrative example, computing device 105 can be implemented using a combination of processors found in computers and hardware units. Processor 110 can have a number of hardware units and a number of processors that are configured to execute software modules 130. In this example, some of the processors can be implemented in the number of hardware units, while other processors can be implemented in the number of processors.

In another example, a bus system can be implemented and can be comprised of one or more buses, such as a system bus or an input/output bus. Of course, the bus system can be implemented using any suitable type of architecture that provides for a transfer of data between different components or devices attached to the bus system. Additionally, communications interface 150 can include one or more devices used to transmit and receive data, such as a modem or a network adapter.

Embodiments and/or implementations can be described in a general context of computer-executable instructions, such as program modules, being executed by a computer. Generally, program modules include routines, programs, objects, components, data structures, etc., that perform particular tasks or implement particular abstract data types.

It should be further understood that while the various computing devices and machines referenced herein, including but not limited to computing device 105, are referred to herein as individual/single devices and/or machines, in certain implementations the referenced devices and machines, and their associated and/or accompanying operations, features, and/or functionalities can be arranged or otherwise employed across any number of devices and/or machines, such as over a network connection, as is known to those of skill in the art.

Turning now to FIG. 2. A schematic diagram is provided showing a detailed internal view of temperature-sensing probe 205. As referenced above, in certain implementations, temperature-sensing probe 205 includes a projecting connector/plug 250, such as a TRS or TRRS connector, as are known to those of ordinary skill in the art. Temperature-sensing probe 205 also preferably includes a thermistor 210 and a resistor 220. Thermistor 210 is operatively connected to a conductor 215 that extends to a particular area or region of connector 250. It should be understood that thermistor 210 preferably changes resistance according to temperature, as is known to those of ordinary skill in the art. Thermistor 210 can be a standard type thermistor used in digital oral thermometers, such as those that have a +/−0.1 C tolerance. Resistor 220 is operatively connected to another conductor 225 that extends to another area or region of connector 250. FIG. 2 depicts an exemplary configuration of the areas of connector 250 and the various connectors that are associated with each area. For example, it can be appreciated that conductor 215 extends to the ‘LEFT’ area of connector 250 (corresponding to the left stereo headphone channel) while conductor 225 extends to the ‘RIGHT area of connector 250 (corresponding to the right stereo headphone channel). As will be described in greater detail herein, by transmitting and receiving signals through the various conductors 215, 225, computing device 105 can compute a measured temperature sensed at probe 205.

In certain implementations, temperature-sensing probe 205 also includes a switch 230. Upon activation of the switch 230, the conductor 215 can be disconnected from thermistor 210, and connected to resistor 220. Additionally, in certain implementations, activation of the switch 230 serves to ground thermistor 210, in a manner known to those of ordinary skill in the art.

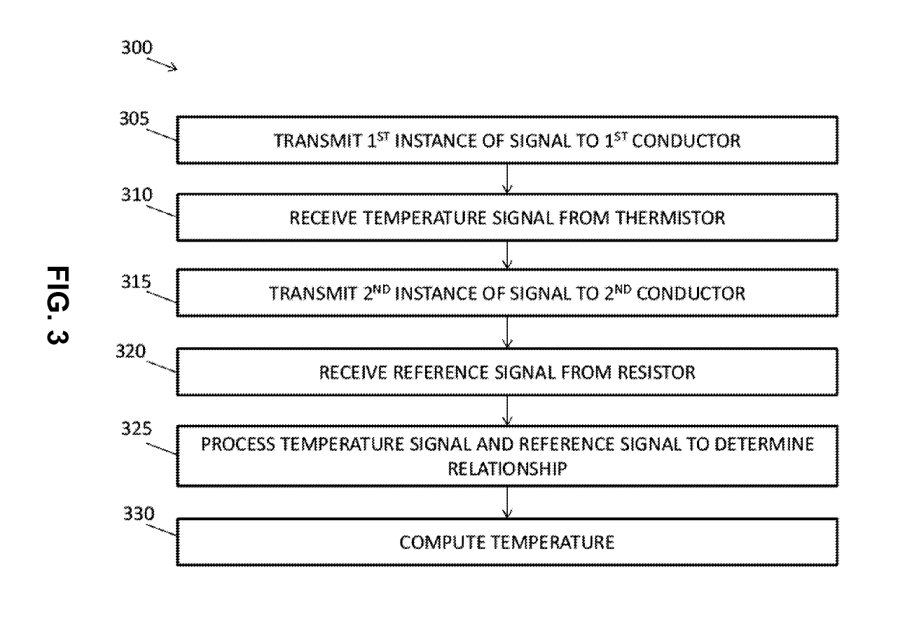

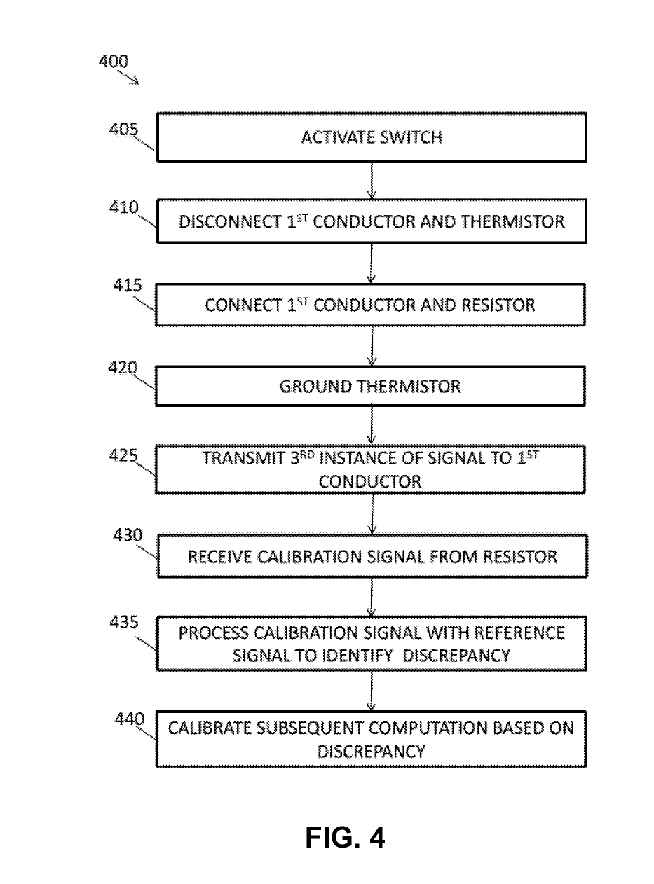

The operation of the temperature measurement subsystem 100 and the various elements and components described above will be further appreciated with reference to the methods described below, in conjunction with FIGS. 3-4.

Turning now to FIG. 3. A flow diagram is described showing a routine 300 that illustrates a broad aspect of a method for measuring temperature in accordance with at least one embodiment disclosed herein. It should be appreciated that several of the logical operations described herein are implemented (1) as a sequence of computer implemented acts or program modules running on computing device 105 and/or (2) as interconnected machine logic circuits or circuit modules within computing device 105. The implementation is a matter of choice dependent on the requirements of the device (e.g., size, energy, consumption, performance, etc.). Accordingly, the logical operations described herein are referred to variously as operations, steps, structural devices, acts, or modules. As referenced above, various of these operations, steps, structural devices, acts, and modules can be implemented in software, in firmware, in special purpose digital logic, and any combination thereof. It should also be appreciated that more or fewer operations can be performed than shown in the figures and described herein. These operations can also be performed in a different order than those described herein.

The process begins at step 305 with processor 110 executing one or more of software modules 130, including, preferably, temperature determination application 170 and/or calibration application 172, configures computing device 105 to transmit a first instance of a first signal to conductor 215. It should be understood that in certain implementations, the referenced first signal (and various other signals referenced herein) is preferably an audio tone (such as a 1 kHz tone). It should be further understood that the signal is preferably output through a specific output of headphone jack 155, such as the left headphone output, as is known to those of ordinary skill in the art. In doing so, the tone can be received by conductor 215 at connector 250 (which also corresponds to the left headphone, and is thus aligned with the appropriate output region of headphone jack 155 when inserted therein).

Then, at step 310, processor 110 executing one or more of software modules 130, including, preferably, temperature determination application 170 and/or calibration application 172, configures computing device 105 to receive a temperature signal from the thermistor 210. Preferably, the temperature signal corresponds to the first instance of the first signal (that is, the signal transmitted at step 305) as output or returned from the thermistor 210. In doing so, the amplitude of the signal being returned from thermistor 210 can be measured, as is known to those of ordinary skill in the art. The amplitude of the signal transmitted at step 305 and the signal received at step 310 can be compared in order to determine the resistance of thermistor 210, in a manner known to those of ordinary skill in the art. Accordingly, it can be appreciated that the larger the resistance of thermistor 210, the smaller this signal can be, based on a simple resistive divider circuit, as is known to those of ordinary skill in the art.

At step 315, processor 110 executing one or more of software modules 130, including, preferably, temperature determination application 170 and/or calibration application 172, optionally configures computing device 105 to transmit a second instance of the first signal to conductor 225.

Then, at step 320, processor 110 executing one or more of software modules 130, including, preferably, temperature determination application 170 and/or calibration application 172, configures computing device 105 to receive a reference signal from the resistor 220. Preferably, the reference signal corresponds to the second instance of the first signal (that is, the signal transmitted at step 305) as output from the resistor 220.

At step 325, processor 110 executing one or more of software modules 130, including, preferably, temperature determination application 170 and/or calibration application 172, configures computing device 105 to process the temperature signal and the reference signal to determine a relationship between the temperature signal (received at step 310) and the reference signal (received at step 320). It can be appreciated that use of this ratiometric method cancels out any effects and tolerances of other conductors (e.g., C2 and R2 in FIG. 2), as well as the input circuitry of computing device 105.

Then, at step 330, processor 110 executing one or more of software modules 130, including, preferably, temperature determination application 170 and/or calibration application 172, configures computing device 105 to compute a measured temperature based on the relationship determined at step 325.

Turning now to FIG. 4. A flow diagram is described showing a routine 400 that illustrates a broad aspect of a method for calibrating a temperature measurement subsystem in accordance with at least one embodiment disclosed herein.

The process begins at step 405 where processor 110 executing one or more of software modules 130, including, preferably, temperature determination application 170 and/or calibration application 172, configures computing device 105 to activate switch 230. Upon activation of switch 230, conductor 215 is disconnected from thermistor 210 (step 410) and connected to resistor 220 (step 415), as referenced above. Activation of switch 230 can also ground thermistor 210 (step 420).

Then, at step 425, processor 110 executing one or more of software modules 130, including, preferably, temperature determination application 170 and/or calibration application 172, configures computing device 105 to transmit a third instance of the first signal to conductor 215.

At step 430, processor 110 executing one or more of software modules 130, including, preferably, temperature determination application 170 and/or calibration application 172, configures computing device 105 to receive a calibration signal from resistor 220. Preferably, the calibration signal corresponds to the third instance of the first signal as output/returned from the resistor 220.

Then, at step 435, processor 110 executing one or more of software modules 130, including, preferably, temperature determination application 170 and/or calibration application 172, configures computing device 105 to process the calibration signal (received at step 430) with the temperature signal (received at step 310). In doing so, one or more discrepancies between the calibration signal and the temperature signal can be identified.

It can be appreciated that the referenced calibration method can be necessary in light of the fact that there is no way to ensure that the left and right headphone outputs of computing device 105 are exactly the same. As such, switch 230 can switch between the normal and calibration mode. In calibration mode, the left headphone output (corresponding to conductor 215) is connected to resistor 220, and thermistor 210 is connected to ground. This in effect simulates swapping the left and right headphone output connections, allowing computing device 105 to determine exactly what the differences are between the left and right headphone outputs. It should be noted that in calibration mode, thermistor 210 is connected to ground (instead of to the right headphone output) in order to enable computing device 105 to definitively determine when the calibration mode has been activated (there will be no input when the computing device drives the right headphone signal).

At step 440, processor 110 executing one or more of software modules 130, including, preferably, temperature determination application 170 and/or calibration application 172, configures computing device 105 to calibrate a subsequent computation based on the discrepancy identified at step 435.

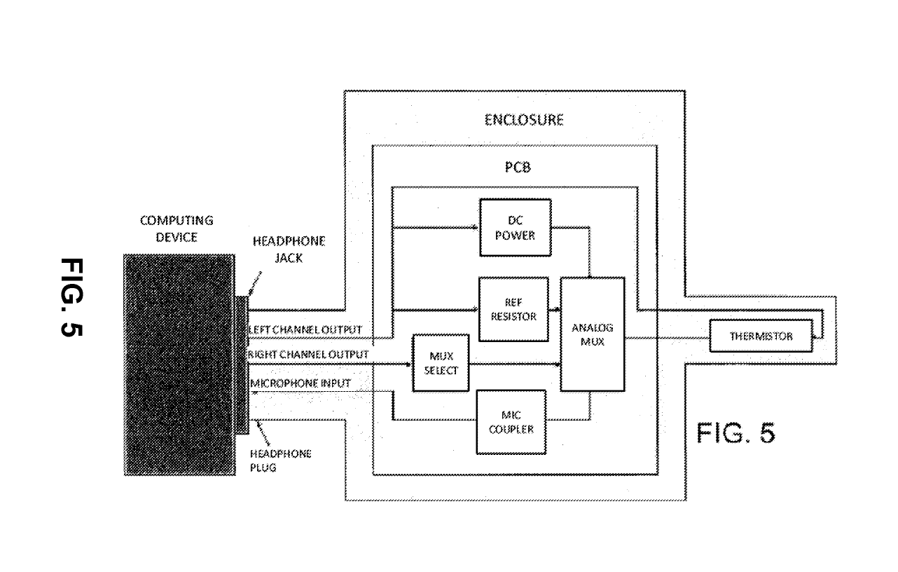

FIG. 5 depicts another implementation of temperature-sensing probe 205, including an enclosure, headphone plug, thermistor, PCB—sections (e.g., as shown in FIG. 6), DC power (the DC power section (D1, C2) generates approximately 1.6 volts from the audio tone on the left channel output for the operation of the analog mux), reference resistor (the reference resistor section (R1, R2) matches the value of the thermistor at 37 C), mux select (the mux select section (D2, C3, R3) generates the mux select from the audio tone on the right channel output), analog mux (the analog mux section (U1) connects the thermistor or the reference resistor from the left channel output to the mic coupler), and/or mic coupler (the mic coupler section (R4, R5) presents the proper resistance (6.8K) to the smartphone microphone input. The mic coupler section also attenuates the left channel output by the correct amount and connects to the smartphone microphone input).

Moreover, in certain implementations, the methods described herein can be configured as follows:

If the temperature determination application detects the correct resistance on the microphone input, then it outputs a tone on the left channel output.

The temperature determination application measures the amplitude on the microphone input and saves it as the thermistor measurement value.

The temperature determination application outputs a tone on the right channel output.

The temperature determination application measures the amplitude on the microphone input and saves it as the reference resistance measurement value.

The smartphone app calculates the thermistor resistance using the ratio of the thermistor measurement value and the reference resistance measurement value.

The temperature determination application calculates the thermistor temperature by using the calculated thermistor resistance and a thermistor RT table or thermistor RT equation.

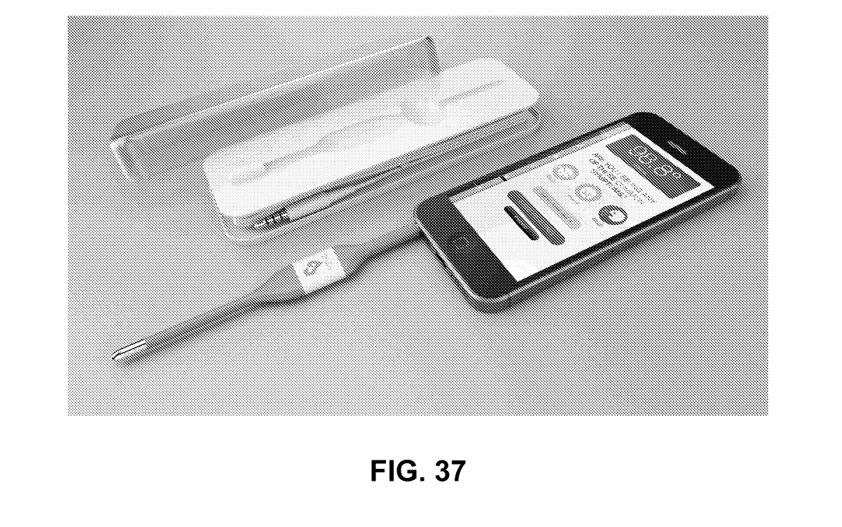

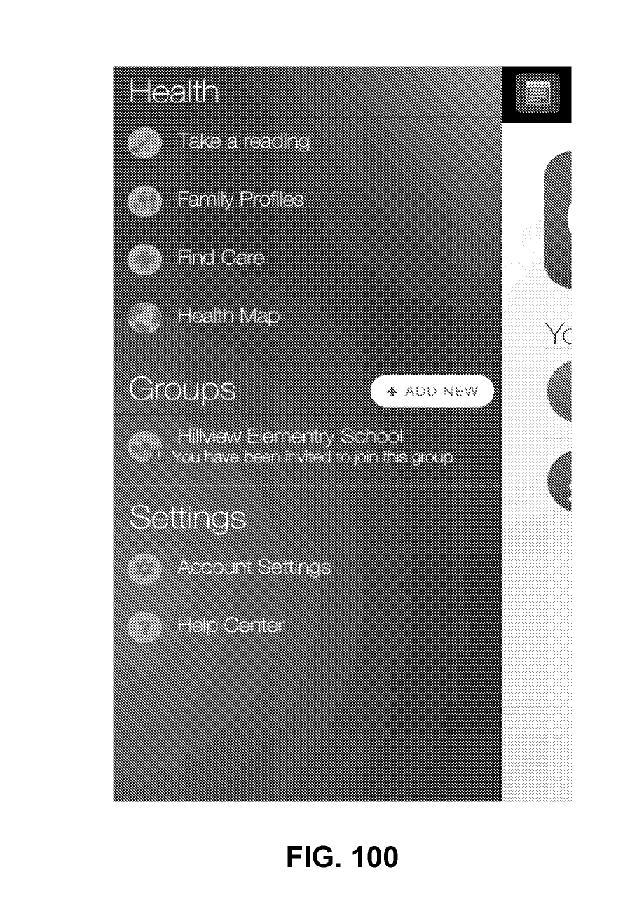

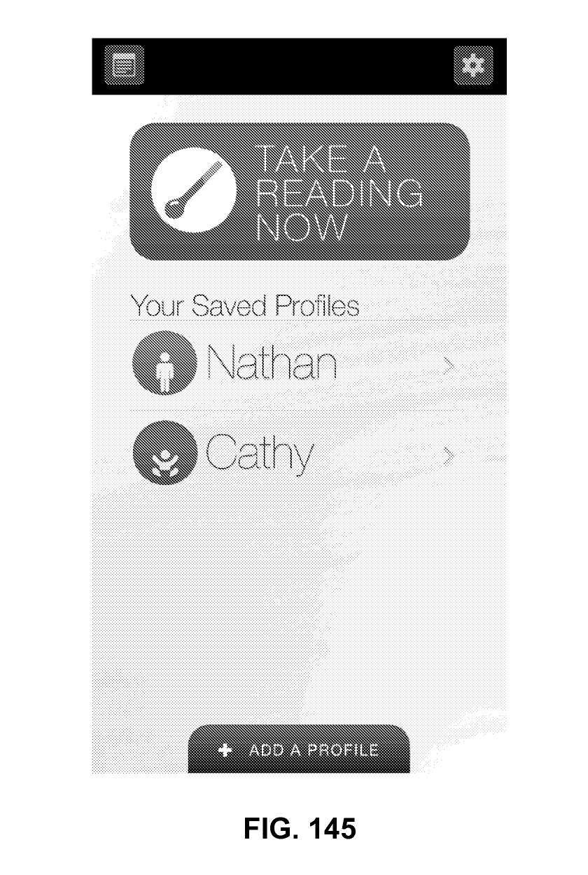

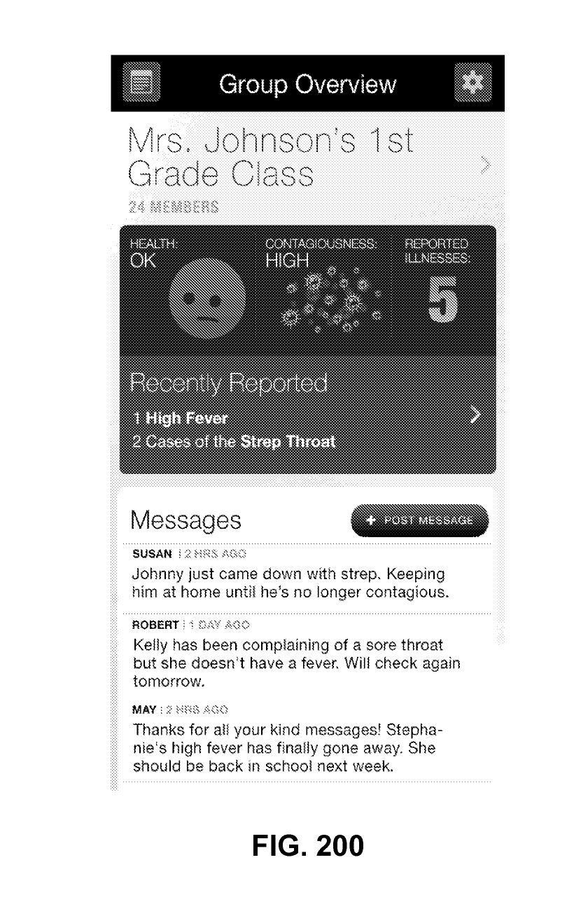

Referring now to FIGS. 100-200, screenshots of the temperature determination application. The following is an outline of the functions and screens of an embodiment of the temperature determination application. As shown in FIG. 100, a “Slide Menu” screen is accessible from multiple other screens (via a menu icon in the upper-left corner), including from the “Take A Reading Now” screen shown in full in FIG. 145 and in part in FIG. 100 (i.e. on the right side of the screen).

The “Slide Menu” screen includes three main menus: the “Health” menu, the “Groups” menu, and the “Settings” menu. Like the “Slide Menu” screen, the “Settings” menu is accessible from multiple other screen (via a settings icon in the upper-right corner).

(1) The “Health” menu provides access to:

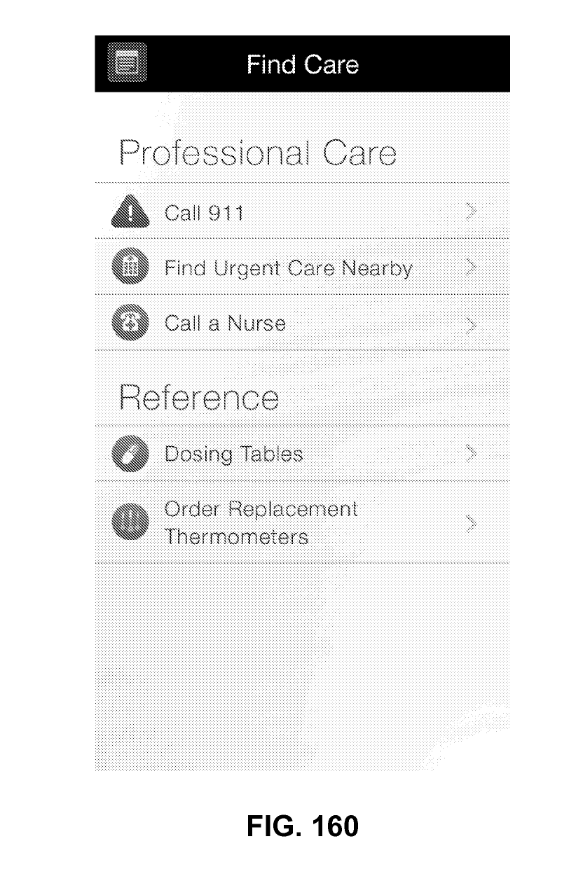

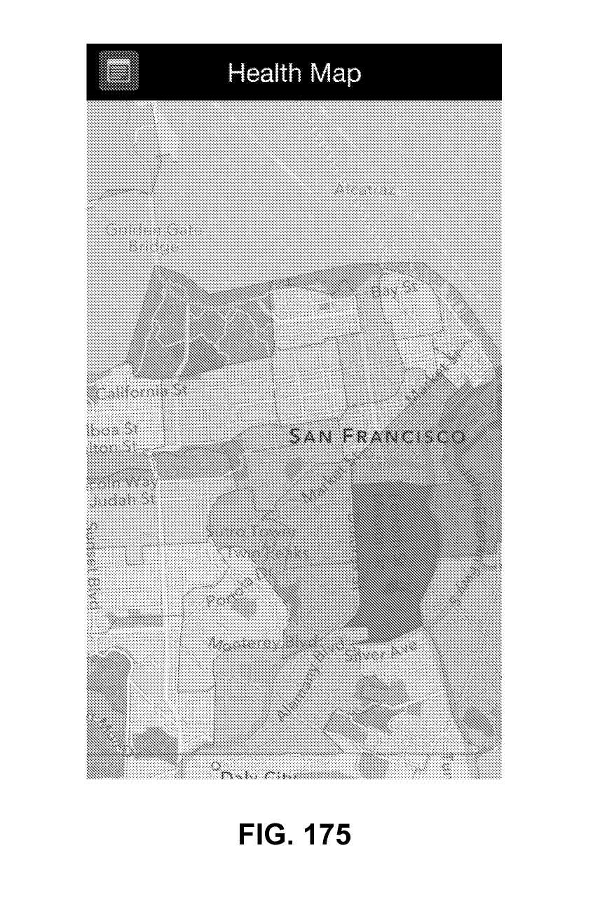

the “Take A Reading” function,
the “Family Profiles—Home” screen (FIG. 145),
the “Find Care” screen (FIG. 160), and
the “Health Map” screen (e.g. FIG. 175).

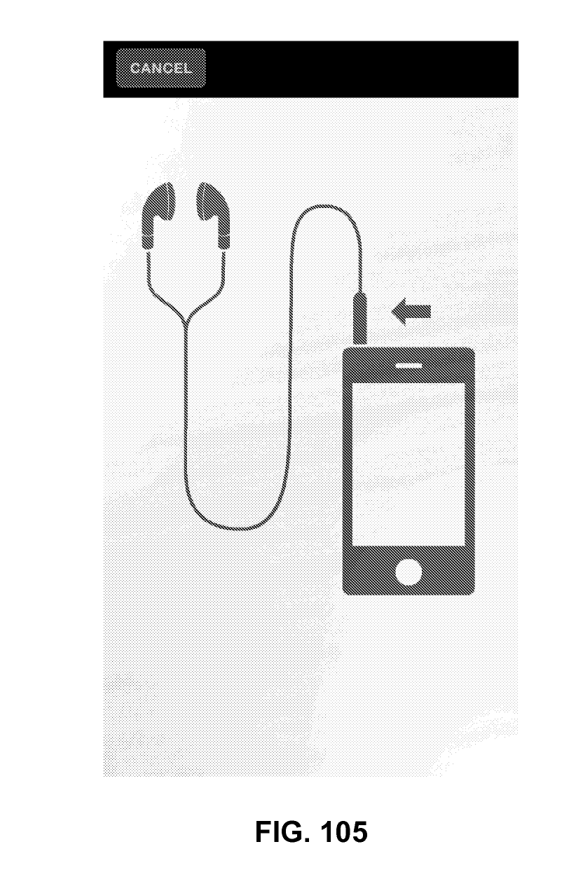

The “Take A Reading” function is accessible from the “Family Profiles—Home” screen (FIG. 145). After selecting the “Take A Reading Now” option, the user is visually prompted (FIG. 105) to remove any headphones/earphones from the smartphone's input cavity/jack (headphone jack, in this example) and to insert the thermometer into the headphone jack (with or without the extension cord).

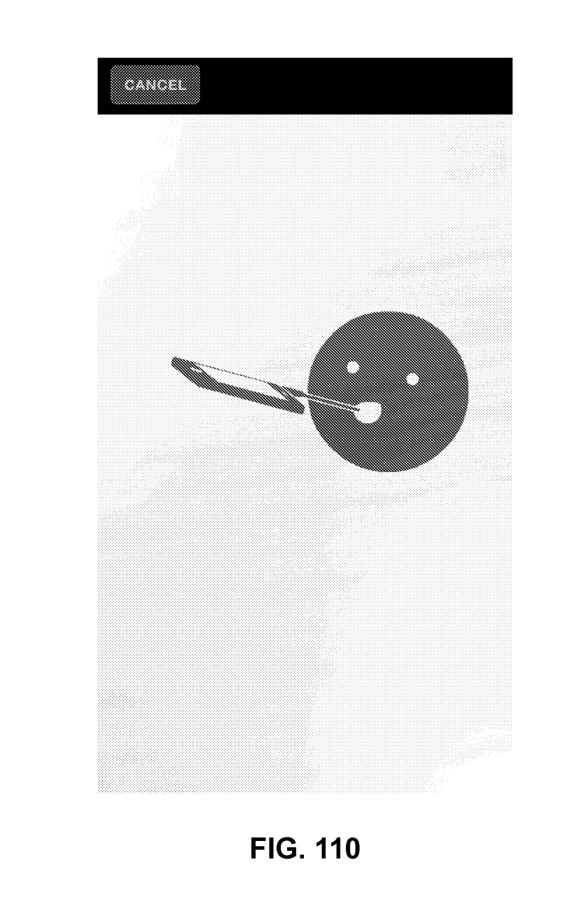

Next, the user is visually prompted (FIG. 110) to insert the thermometer into the patient's mouth.

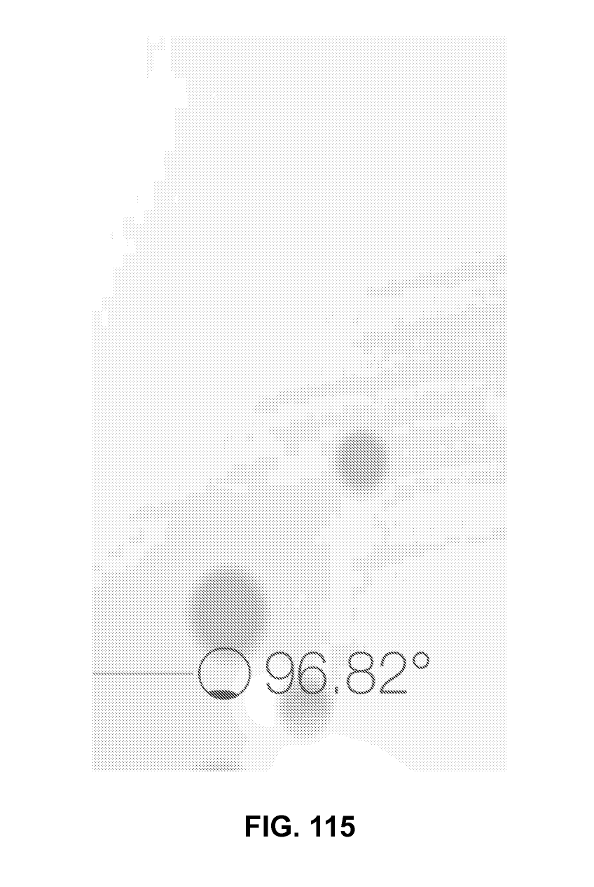

Next, the “Temperature Taking” screen (FIG. 115) optionally displays visual elements and plays audio, both of which are designed to distract a sick child. These features can be enabled/disabled from each patient's profile.

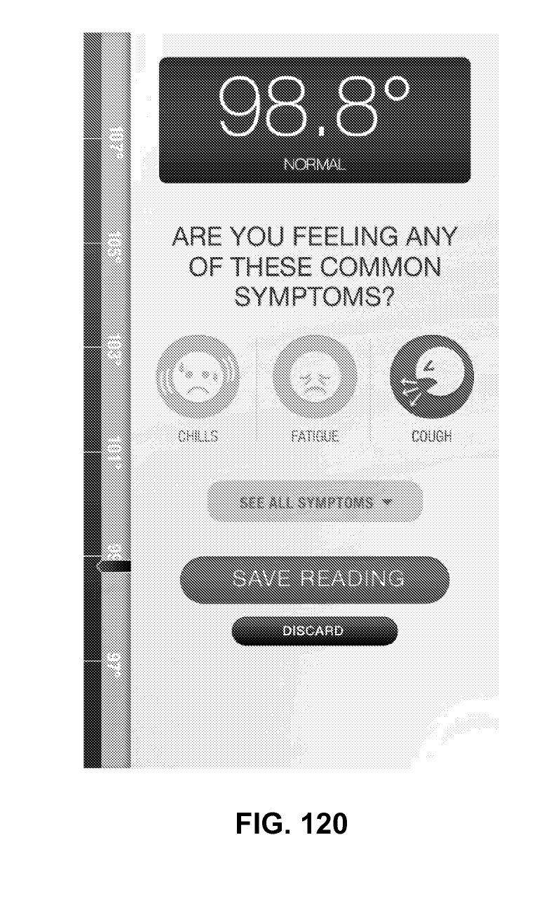

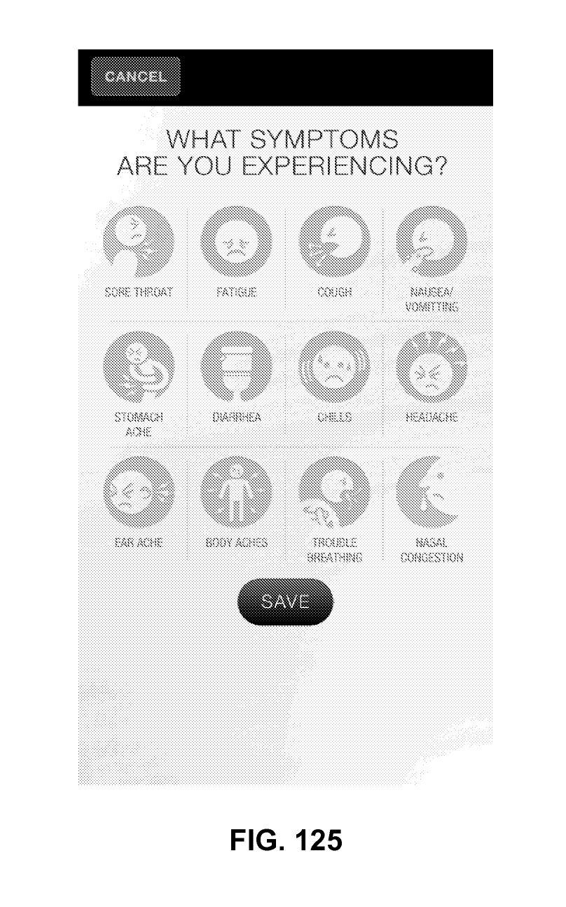

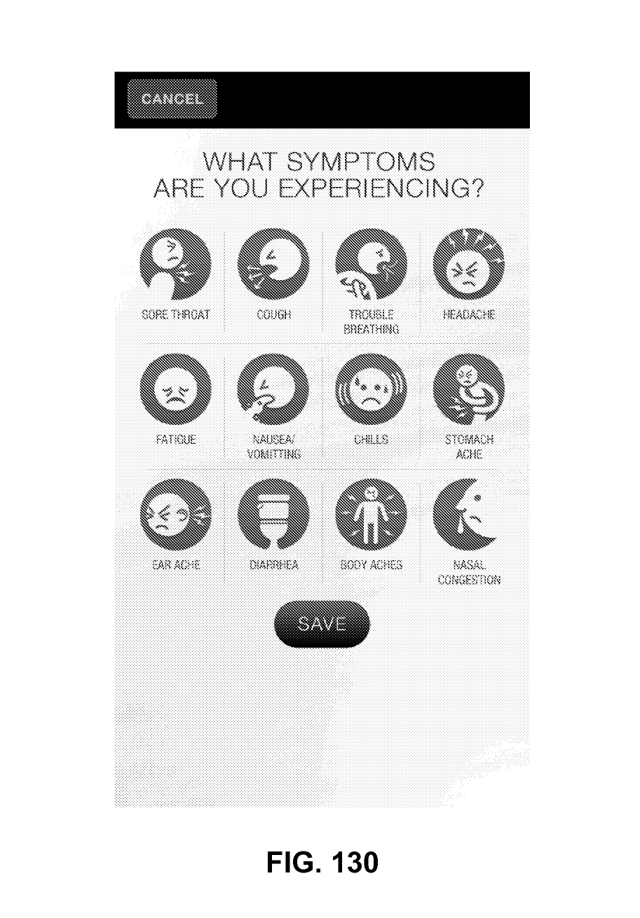

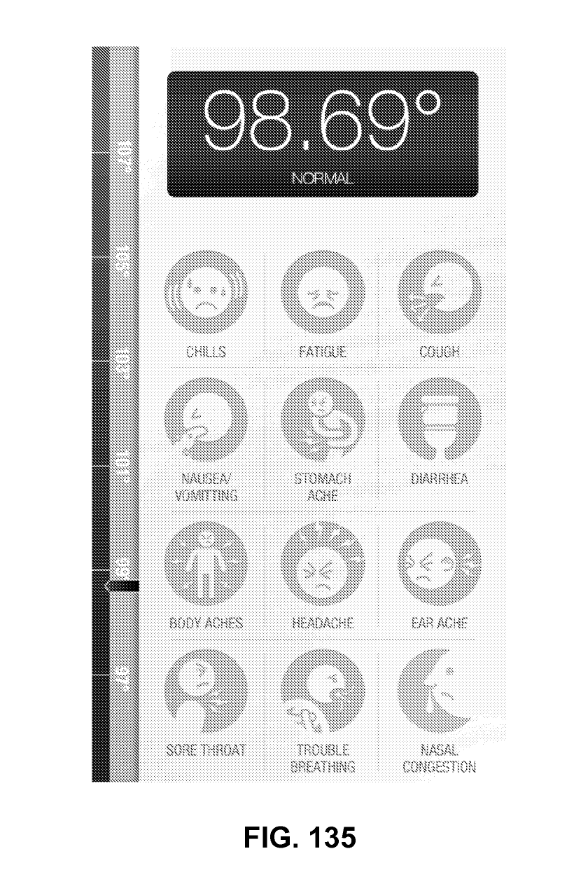

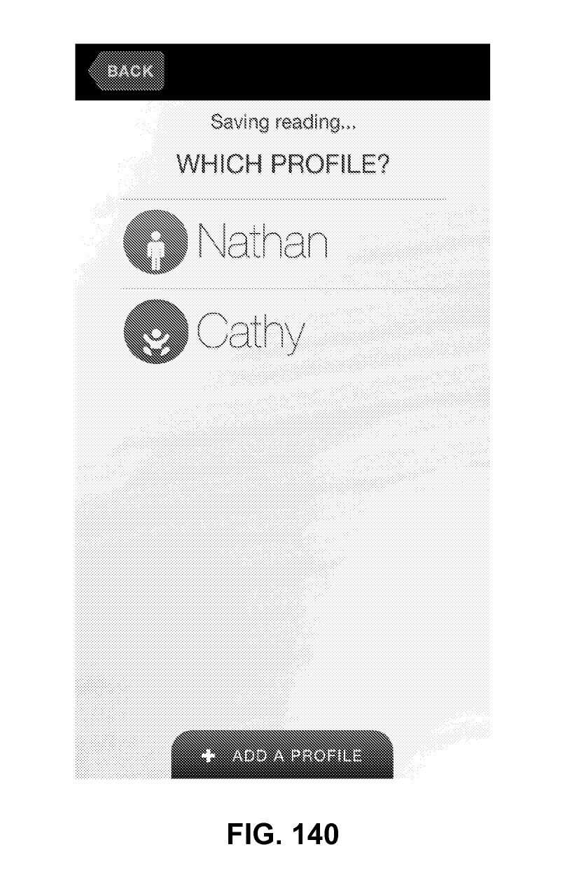

Next, the “Post Temperature Reading” screen (FIG. 120) is displayed, which prompts a user to identify other symptoms that the patient may be experiencing. In this example, the possible symptoms include sore throat, cough, trouble breathing, headache, fatigue, nausea/vomiting, chills, stomach ache, ear ache, diarrhea, body aches, and nasal congestion. When a user selects the “See All Symptoms” option, the “All Symptoms” screen (FIG. 125 shows no options selected, FIG. 130 shows all options selected) is displayed. Referring again to FIG. 120, the user in the example has selected cough as a symptom. The measured temperature is displayed digitally on the top of the screen and like a traditional analog liquid-filled thermometer along the left side (FIG. 135). The user can select the “Save Reading” option to save the reading or the “Discard” option to discard the reading. As shown in FIG. 140, the saved reading can be associated with a saved profile for a patient (Nathan or Cathy, in this example), or a user can add a new profile by selecting the “Add A Profile” option. One can appreciate that this features allows a user to track a patient's symptoms over time, share this history with others, such as a doctor or other healthcare provider for improved diagnosis or care, or, when a patient is in the care of a parent, with their spouse or babysitter to ensure proper care for the child over time. One can also appreciate that this feature simultaneously allows the provider of the system to gather additional geo-located data on symptoms.

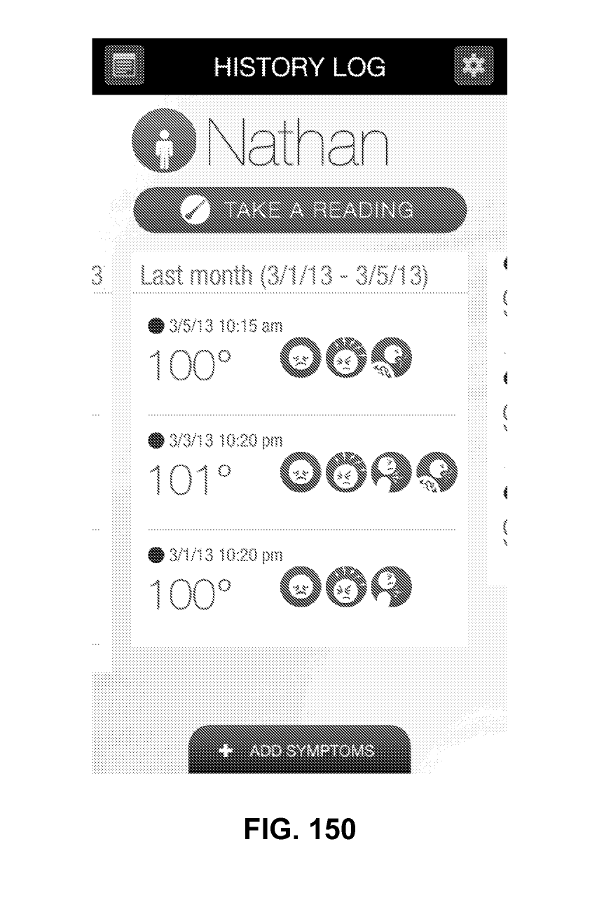

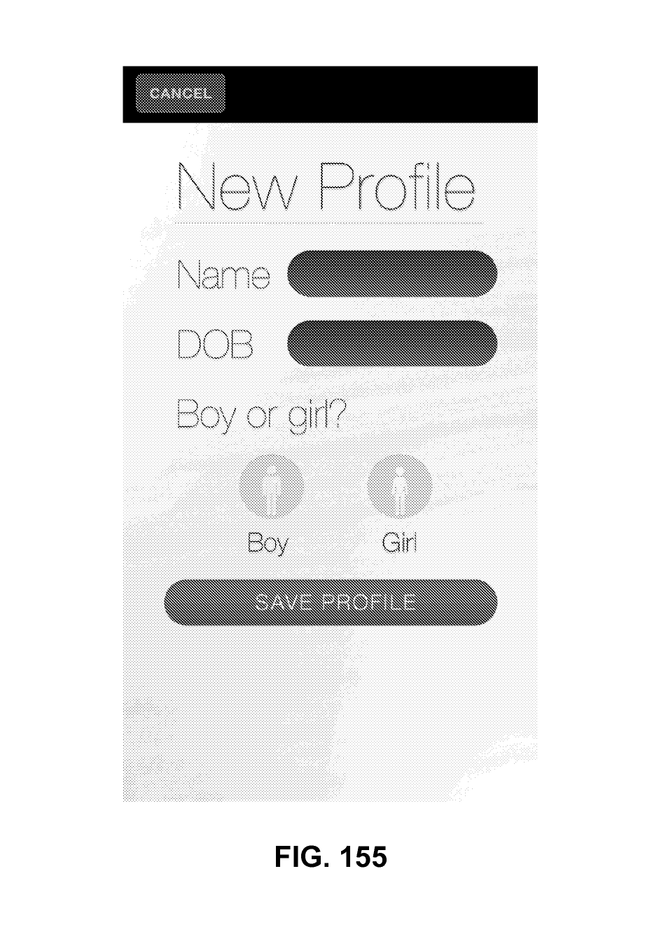

From the “Family Profiles” screen (FIG. 145), a user can select the “Take A Reading Now” option, can select the “Add A Profile” option, or can access a saved profile for a patient (Nathan or Cathy, in this example). From the “User Profile—History Log” screen (FIG. 150, Nathan, in this example), a patient's symptom history is displayed along with the “Add Symptom” option. If the “Add A Profile” option is selected from the “Family Profiles” screen, then the “Create Profile” screen (FIG. 155) is displayed, and the profile can be saved by selecting the “Save Profile” option.

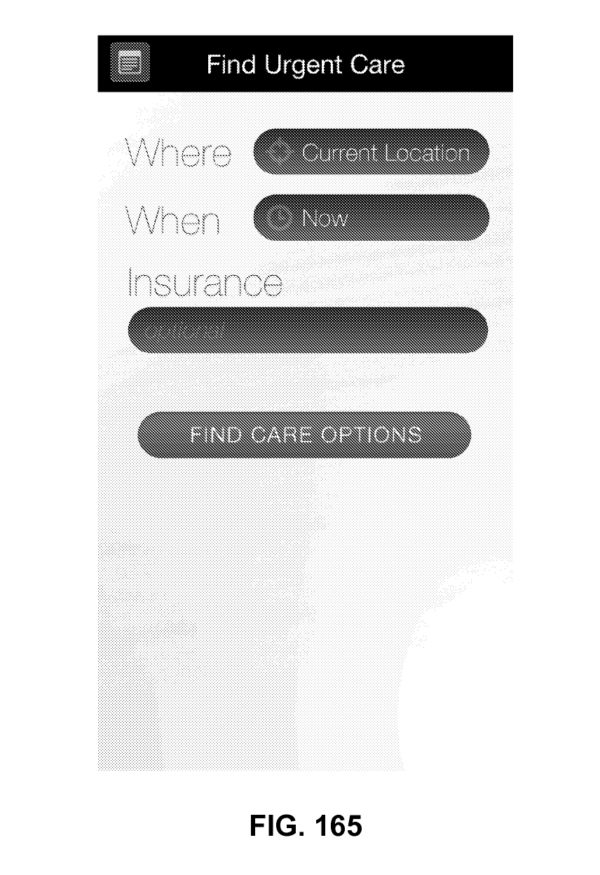

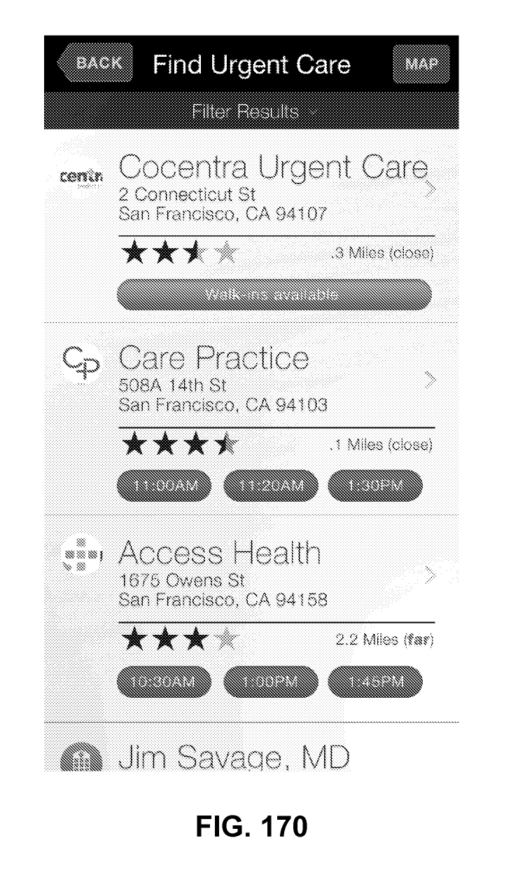

From the “Find Care” screen (FIG. 160), a user can choose from professional care options, including “Call 911,” “Find Urgent Care Nearby”, and “Call A Nurse” and reference options including “Dosing Tables” (which includes recommended dosage levels for medications) and “Order Replacement Thermometers.” If the “Find Urgent Care Nearby” option is selected, then the “Find Urgent Care—Input” screen (FIG. 165) is displayed, where information such as where, when, and insurance can be entered. When the user selects the “Find Care Options” option, the “Find Urgent Care—Output” screen (FIG. 170) is displayed and includes results based on the information input by the user. The displayed results can be filtered by distance, name, user ratings, and other options. The use of this feature allows the provider of the system to gather additional data on treatment-seeking behavior.

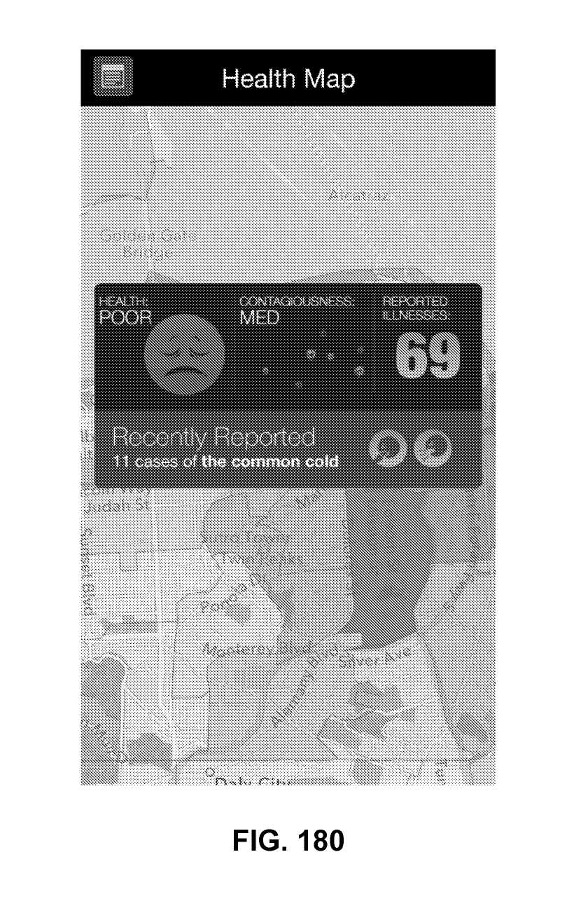

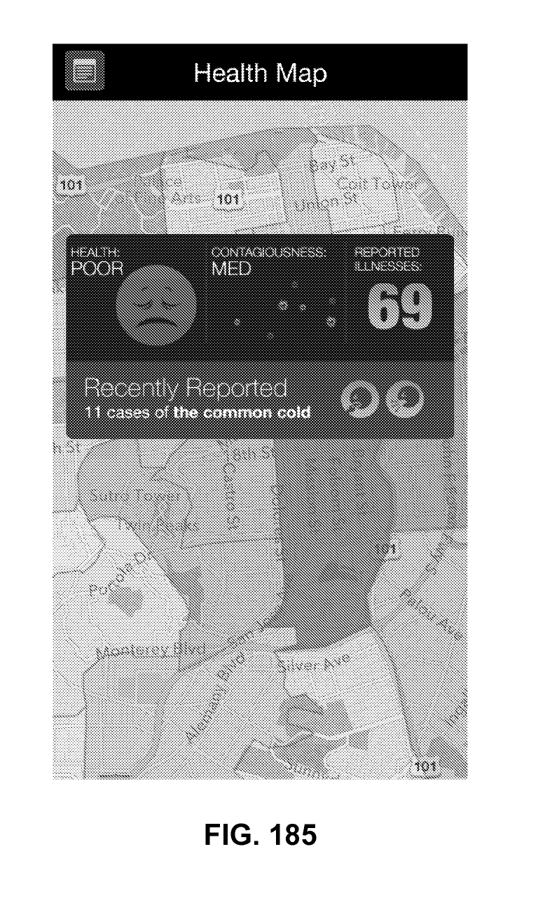

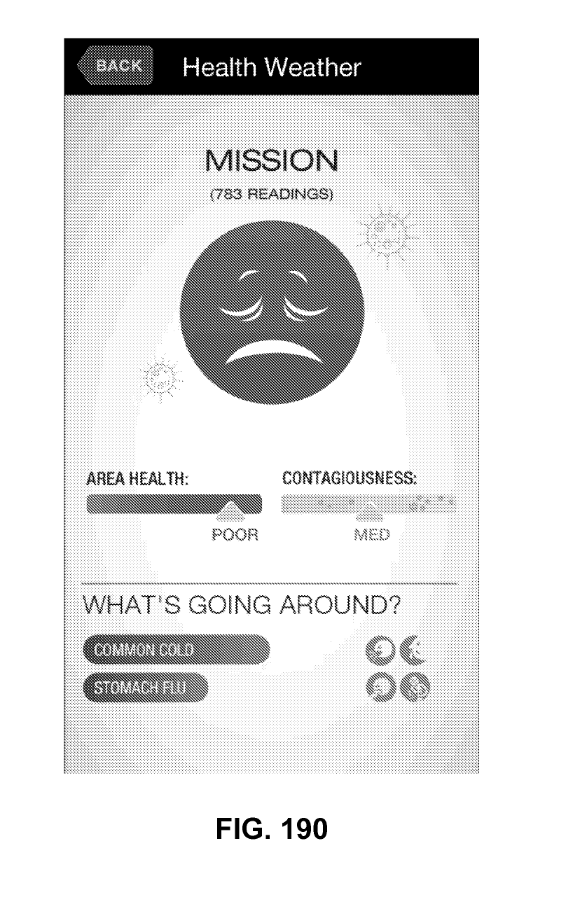

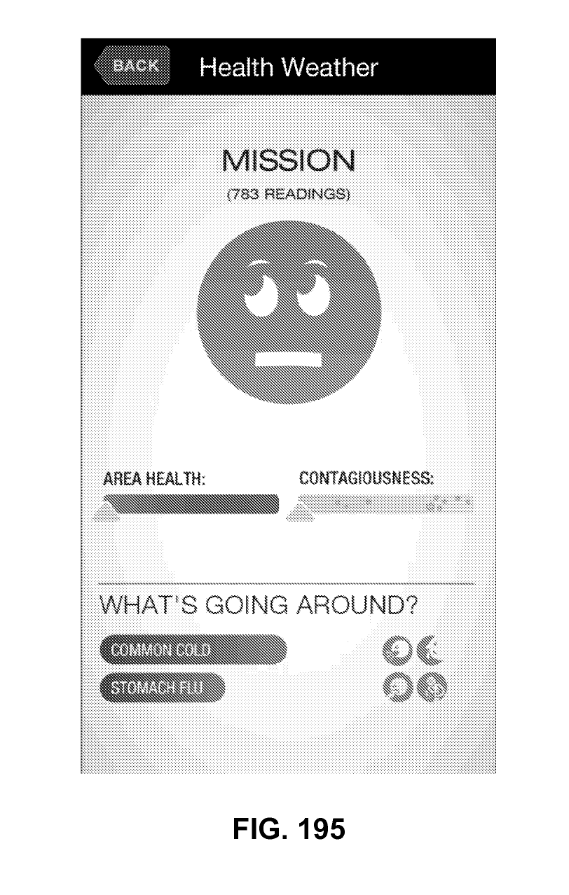

From the “Health Map” screen (FIG. 175), a user can see his/her current location on a map (San Francisco's Mission District, in this example) and can zoom in or out on the map using known smartphone map navigation means. For selected areas, aggregated health care data for patients in the displayed geographic area is displayed as in the “Health Card” screens shown in FIG. 180 and FIG. 185. These screens show the overall health, contagiousness, reported illnesses, and recently reported cases (of the common cold, in this example) with text and/or non-text elements in a particular geographic area. Tapping on the “Health Card” shown in FIG. 185 displays the “Health Weather” screen (FIG. 190 and FIG. 195), which adds time-based data to the location data displayed in the “Health Map” screen, such as incorporating past health care data (historical data), present health care data (real-time data), and future health care data (predictive data). Just as a television meteorologist informs television viewers about past weather data, current weather conditions, and the (future) weather forecast, “Health Weather” incorporates time data to inform users about past, current, and (future) forecasted health for a geographic area or group. This feature allows the provider of the system to collect information about the location and presence of various symptoms and illnesses, advancing the mobile-enabled health system described herein.

(2) The “Groups” menu provides access to the screens corresponding to the groups that a user has already created or joined (FIG. 200) and the “Add New” option, which displays the “Create Group” screen (not shown). One can appreciate that joining a group allows the provider of the system to understand information about relationships between various users. This information includes (a) people-to-people relationships, such as which users interact with other users, which can be used to understand information about the rapidity of the illness' or symptom's spread and/or which users may have spread the illness/symptom to the others and (b) people-to-location relationships, such as which users frequent which locations, which can be used to analyze nodes of disease transmission to understand where illness is being primarily spread. In the preferred embodiment of this feature, schools (including preschools and early education centers, kindergartens, elementary schools, and high schools) are pre-loaded groups that users can join. As any parent can appreciate, schools are a primary node of the spread of many communicable illnesses including, for example, influenza and strep throat among other illnesses. An understanding of the illness situation at an school can lead to powerful predictive analytics about how the illness/symptom will affect the broader adult community, perhaps a week or so later.

The “Groups Overview” screen (FIG. 200) displays aggregated health care data for a group of users (Mrs. Johnson's 1st Grade Class, in this example). Like the “Health Card” screen, the “Groups Overview” screen shows the overall health, contagiousness, reported illnesses, and recently reported cases (of high fever and strep throat, in this example) with text and/or non-text elements in a particular group. Additionally, group pages have messaging functionality using known smartphone messaging means.

(3) The “Settings” menu provides access to the “Account Settings” screen (not shown) and the “Help Center” screen (not shown).

In an additional “illness outlook” feature, not shown here, the provider of the system provides useful information to the user about their illness, for example, when the user is/was contagious and when he/she will no longer be contagious. This information is provided to the user in exchange for the user inputting information about a confirmed doctor's diagnosis into the smartphone application that is bundled with the software. One can appreciate that such planning information is of value to the user and is not often provided to patients by their doctors, who focus more on communicating diagnosis and treatment. One can appreciate that such a feature, when bundled with a smartphone-connected thermometer, can be dynamically presented to a user. For example, a user has a high fever for three days. In this case, the user has a higher likelihood of having already seen a doctor than if they had had a fever for only one day. The application prompts the user asking “Have you seen a doctor?” If the user enters “yes” then the application asks the user a number of additional questions in order to provide the user with information about contagiousness as described in this paragraph. One can appreciate that such a feature will allow the provider of the system to gather other data including geo-located data on confirmed illness, or geo-located data on various aspects of the illness. One can also appreciate that contagiousness is but one piece of information that such a feature could provide to the user. Other such information can also be provided, enhancing the value of this feature, encouraging its use, and advancing the ability of the system to gather geo-located data on illness.

3. Sending Health Care Data to a Data Repository and Aggregating Collected Health Care Data with Existing Health Care Data

Also described herein are various technologies that enable the collection of location data on symptoms and illness. Components of such technologies include the application of mobile, software, and proprietary technologies to existing health care products and devices, and methods and systems that enable the aggregation of collected data with existing historical health care data and/or location data, social network data, and/or data on movement/behaviors of populations. Various implementations of the described technologies provide substantial advantages in biodefense and health surveillance settings, including early warning, planning, and identification of emerging illness, symptoms, and/or pathogens.

After the temperature determination application has saved health care data (such as a measured temperature), the health care data can be sent from the smartphone to a data repository using known transmission means. In one embodiment, the data repository includes server computers operable to store data in a database using known means.

Moreover, in certain implementations, health care data (such as temperature data) determined/identified by way of the various methods and systems described herein, can be further collected, analyzed, and leveraged to enable the tracking and prediction of various health-related phenomena, among other advantages. In certain implementations, medically accurate, real-time, and/or location data (such as data pertaining to various symptoms and/or illness) can be received/generated at various remote sites/devices, such as smartphones (such as those equipped with the various temperature-sensing technologies described herein) and provided to a data repository. It can be appreciated that, in various implementations, any number of mobile computing devices, applications, peripherals/proprietary technologies, and/or pre-existing health care products/devices can interface with one another to enable the identification and/or collection of health care data. Such data can also be aggregated and/or correlated with existing historical health care data (including location-based data, and/or social network data) in order to further enhance and improve the veracity of the collected health care data (ensuring a high signal-to-noise ratio (SNR)) and further enabling analysis of health care data in view of such location data and/or social network data. In doing so, a health surveillance and biodefense tracking system, among other features and advantages, can be deployed, enabling, for example, early warnings, planning, and identification of emerging illness, symptoms, and/or pathogens.

The technologies described herein provide numerous advantages over traditional provider-initiated reporting and more recent computational efforts. By collecting medically accurate data from patients in their natural locations (e.g., homes, workplaces, etc.), even before they enter the health care system (e.g., visit a doctor or hospital), the technologies described herein not only overcome the time lag of the current provider-initiated reporting system and ensure high reporting levels, but also facilitate high SNR and enable near-real-time detection of disease outbreaks and bioterrorism events, substantially earlier and more accurately than would be possible under other health care data aggregation approaches. Additionally, the collected and analyzed health care data can be further processed to enable a predictive capability with respect to outbreak monitoring by combining health care data collected with health care data from providers, from geography (i.e. location data), from social networks (i.e. social network data), and/or from behavior/movement (i.e. behavior/movement data).

Examples of health care data that can be collected through the use of the application software bundled with the thermometer, as described herein, or through other means or channels, and then aggregated, correlated, and/or analyzed through the mobile enabled health system described herein include, but are not limited to:

### 1. Illnesses;

2. Symptom data;
a. General symptoms (e.g. fever);
b. Specific symptoms indicative of specific illnesses (e.g., barking cough for a strong signal of croup presence);
c. Other major symptoms;
   3. Time of incidence of the above illnesses and/or symptoms;
   4. Places a patient frequents;
   5. Other people a patient is commonly in physical proximity to;
   6. Age of patient;
   7. Behavior of users within the temperature determination application;
a. Frequency of use of the temperature determination application and specific features/functions;
b. When users create new places or groups; and
c. When users invite others.
d. Notes: The above data can be indicative of a user's vigilance for a patient's health (noting that the patient and the user of the temperature determination application may be the same or different people). Vigilance can be considered along three dimensions: (1) treatment vigilance (how vigilant patients are when sick), (2) prevention vigilance, and (3) parenting vigilance (or caregiver vigilance).

There may also be other behavioral implications:

8. Others in a user's social network;
9. Utilization of coupons for health care products (indicative of illnesses/symptoms); and
10. Which treatments a patient is taking.

As referenced above, it can be appreciated by one of ordinary skill in the art that the various technologies described herein can be implemented using presently available mobile technologies (e.g., smartphones) together with commonly available health care products/devices.

### 4. Sharing Health Care Data

With the invention, health care data can be shared with patients, users, and/or the general public via one ore more applications.

With the invention, a real-time map of human health is created. The map of human health includes information about where, when, and what types of illnesses are spreading, and associated relationship data (e.g. to which groups, schools, and locations (geo-nodes) these illnesses are associated).

For example, the temperature determination application transmits data on fever and location while the accompanying software features bundled with smartphone-connected thermometer transmits additional geo-located health care data (e.g., symptoms, specific illnesses and relationship data, as described herein) to the data repository. Once this data on fever and location is transmitted to data repository, the data is aggregated with data from other users to develop an understanding of the level of fever, symptoms, illness, where these are occurring, their incidence, their prevalence, and the rate at which they are spreading or could spread given the number of people exposed or expected to be exposed. The application determines and/or accounts for relative proximities and relationships between ill persons, and such data is further correlated, for example, with historical health care data and other external data sources described herein. Information, including alerts and context (e.g. the level of fever or associated symptoms, where it is, whether it is at your child's school), is then transmitted back to (i.e. shared with) the user for consumption at a mobile computing device (such as via the temperature determination application). This information can also be shared with other users, some of which may not be ill, so they can get an understanding of the health situation in their area, for example, to avoid getting ill in the first place.

A health weather map application executes at a the data repository and enables the processing, sharing, and aggregation of any/all health care data collected, such as health care data pertaining to human fever, illness, and/or symptoms. Such health care data is collected, for example, as described herein, and is further combined with other data sources as described herein. Contextualized health care data from the health weather map application is displayed on a smartphone mobile application and/or a via a web browser. In doing so, public health officials and others track and anticipate/predict the spread of disease. Moreover, other health-related parties and entities (e.g., private sector organizations such as pharmacies) are enabled to target appropriate products (such as Tamiflu®) and interventions, and are provided with context to support doctors with diagnoses, based on the collected/analyzed data. Additionally, in certain implementations, social networking features enable the visual depiction of health trends directly relevant to individuals, families, and communities, while also facilitating better use of health resources, thereby enabling better outcomes.

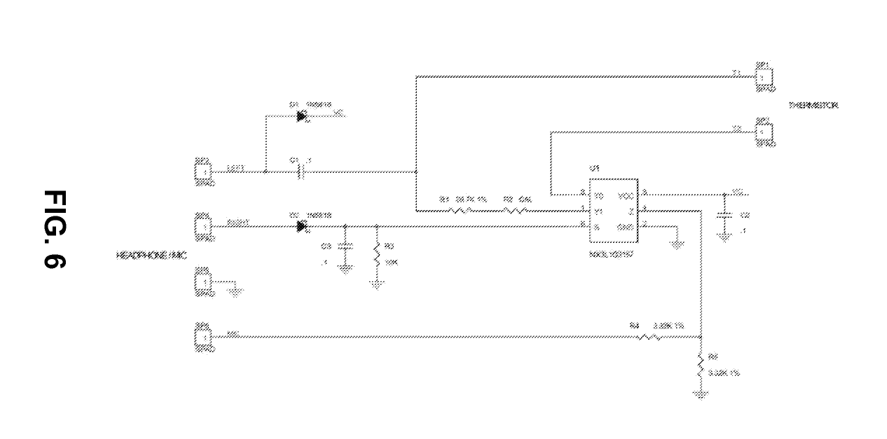

Turning now to FIG. 7, a view of the architecture of the system. A thermometer 1010 connects to a mobile application 1030 (such as the temperature determination application) running on a mobile device (not shown) such as a smartphone. The thermometer 1010, the smartphone (not shown), and the mobile application 1030 together form the smartphone subsystem. The thermometer 1010 is inserted into the mouth of a patient (not shown) by the patient or another user (not shown) and together with the mobile application 1030 computes the measured temperature of the patient. The measured temperature is one kind of health care data that can be collected by the smartphone subsystem.

When a user of mobile application 1030 completes certain actions, events are triggered, data is created (behavior/movement data sources 1060) and health care data (including behavior/movement data) is transmitted from the smartphone (not shown) to the data repository 1050 (not shown), the data repository in turn having application server 1053, analytics server 1056, and database 1059. Example of such triggering events include, but are not limited to, the following:

1. If a user completes a temperature reading, then temperature data, date/time data, geo-location data are transmitted to data repository 1050.
2. If a user selects symptoms and saves them to a profile, then symptom data, date/time data, and geo-location data are transmitted to data repository 1050.
3. If a user indicates whether or not he/she has seen a doctor, then a new illness episode is transmitted to data repository 1050.
4. If a user selects a diagnosis, then illness data, date/time data, and geo-location data are transmitted to data repository 1050.
5. If a user answers diagnosis-specific questions, geo-located data and the responses to the questions (which are additionally associated to an illness episode) are transmitted to data repository 1050.
6. If a user joins a group, then user-to-group association data is transmitted to data repository 1050.
7. If a user creates a group, the group name and optionally the geo-location of the group are transmitted to data repository 1050.

In short, nearly any user action while using the application generates data that can be transmitted to data repository 1050.

Example of behavior/movement data sources include data on movements of populations, such as data from mobile phones that track movements (e.g. Foursquare, Google Latitude, Glympse, Life360, MapTrack) and attendance information (e.g. from schools).

In addition to data generated by users of mobile application 1030 and related applications running on the smartphone, data repository 1050 receives data from external data sources 1070 (not shown), such as public health data sources 1074 and social networks 1078. An example of public health data sources 1074 is CDC public health care data. An example of social networks 1078 data is data obtained from the mining of various social networking data (e.g., Twitter) for disease-related terms. Another example of social networks 1078 data is Google data accessible via various APIs.

At the data repository 1050, collected data is aggregated and analyzed resulting in contextualized health care data (i.e. health care data with context). Selected contextualized health care data can then be shared via Internet 1040 to computing devices (not shown) running web browser 1020 and/or mobile app 1030. Two types of data are most ideally suited for sharing, namely:

(1) A static representation of the data (which focuses on the location data) is called the “health map” and can be global, national, regional, or local. A local “health map” is ideally suited for viewing on a smartphone.

(2) A dynamic representation of the data (which focuses on the date/time data) is called the “health weather” and has three components:
(a) past (based on historic data);
(b) present (based on real-time data); and
(c) future (based on predicted data).

### 5. Taking Action for Better Outcomes

Accordingly, through the collection, aggregation, and/or analysis of symptom, fever, and illness data provided by users, including at intervals prior to patients entering the health care system, the technologies describe herein yield significant advantages and efficiencies in settings such as public health and biosurveillance.

Moreover, in certain implementations, features are incorporated/integrated, whereby relevant and actionable information is generated and provided to a user (e.g., pertaining to what to do when a patient first falls ill as well as information on illnesses or symptoms that are circulating in their local area), as can be generated based on the collected data.

Additionally, in certain implementations, various features and functionalities enable the collection of more nuanced symptom data in order to help identify nodes of disease transmission and potentially self-reported confirmatory diagnoses. For example, using the temperature determination application, a user can interact with a “wizard” checklist based on the nurse call center triage protocol. Doing so enables the user to determine appropriate next steps and provides real-time access to symptoms beyond fever. It can be appreciated that many patients reach the peak of their concern when they first confirm that they are ill, and strategic positioning of features during this time can mitigate against widespread falsification of data collected. Additionally, platform integration with other health care data sources and location-based apps can act as a secondary buffer against noise.

In certain implementations, data (e.g., projections, etc.) generated by the various technologies described herein can be evaluated/validated against results from provider-initiated reporting using the number of reported cases and timeliness of cases reported as the primary evaluation criteria (e.g., to identify the beginning/peak of flu season).

### Other Embodiments

At this juncture, it should be noted that although much of the foregoing description has been directed to systems, methods, and apparatuses for measuring temperature and/or calibrating a temperature measurement subsystem, the systems and methods disclosed herein can be similarly deployed and/or implemented in scenarios, situations, and settings far beyond the referenced scenarios.

It is to be understood that like numerals in the drawings represent like elements through the several figures, and that not all components and/or steps described and illustrated with reference to the figures are required for all embodiments or implementations. It should also be understood that the embodiments, implementations, and/or implementations of the systems and methods disclosed herein can be incorporated as a software algorithm, application, program, module, or code residing in hardware, firmware and/or on a computer useable medium (including software modules and browser plug-ins) that can be executed in a processor of a computer system or a computing device to configure the processor and/or other elements to perform the functions and/or operations described herein. It should be appreciated that according to at least one embodiment, one or more computer programs, modules, and/or applications that when executed perform methods of the present invention need not reside on a single computer or processor, but can be distributed in a modular fashion amongst a number of different computers or processors to implement various aspects of the systems and methods disclosed herein.

Thus, illustrative embodiments and implementations of the present systems and methods provide a computer-implemented method, computer system, and computer program product for measuring temperature and/or calibrating a temperature measurement subsystem. The flowchart and block diagrams in the figures illustrate the architecture, functionality, and operation of possible implementations of systems, methods, and computer program products according to various embodiments and implementations. In this regard, each block in the flowchart or block diagrams can represent a module, segment, or portion of code, which comprises one or more executable instructions for implementing the specified logical function(s). It should also be noted that, in some alternative implementations, the functions noted in the block may occur out of the order noted in the figures.

For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

For example, the components of the data repository (including the application server, application server, and database) can be implemented on one or more physical computers, one or more virtual computers, central or distributed computers, or any combination thereof.

For example, in another embodiment, the system is adapted to work with animals instead of humans, veterinarians instead of human doctors, in the context of illnesses affecting non-humans.

The phraseology and terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. The use of “including,” “comprising,” or “having,” “containing,” “involving,” and variations thereof herein, is meant to encompass the items listed thereafter and equivalents thereof as well as additional items.

It is to be understood that the above description is intended to be illustrative, and not restrictive. Many other embodiments will be apparent to those of skill in the art upon reviewing the above description. The scope of the invention should, therefore, be determined with reference to the appended claims, along with the full scope of equivalents to which such claims are entitled.

The subject matter described above is provided by way of illustration only and should not be construed as limiting. Various modifications and changes can be made to the subject matter described herein without following the example embodiments and applications illustrated and described, and without departing from the true spirit and scope of the present invention, which is set forth in the following claims.

1-11. (canceled)

12. A health monitoring and tracking system, the system comprising:
a plurality of temperature sensing devices, each of the temperature sensing devices communicatively connectable to at least one of a plurality of respective computing devices and configured to calculate temperature information, independently or in connection with the respective at least one computing device;
at least one data repository that stores health data from a plurality of the respective computing devices, wherein the health data includes at least calculated temperature information and patient information for a plurality of patients; and
at least one processor that is configured to execute instructions stored on non-transitory processor readable media, which configure the at least one processor to:
aggregate at least some of the health data stored in the at least one data repository;
process the aggregated health data to generate health information associated with a plurality of people in a population; and
transmit the generated health information over a communication network to at least one computing device.

13. The system of claim 12, wherein the patient information includes at least one of:
geographic information representing a location of a respective user;
symptom information representing a symptom of the user associated with an illness or ailment;
clinical information representing at least one characteristic of the user associated with an illness, ailment or temperature;
date information representing a date and/or time associated with at least one of the calculated temperature information, the symptom information, and the clinical information;
patient identification information representing a user or an individual associated with a user;
a device id;
the health information; and
the temperature information.

14. The system of claim 13, wherein the at least one processor is further configured to execute instructions stored on non-transitory processor readable media, which configure the at least one processor to:
track spreading of an illness as a function of at least one of the geographic information, the symptom information, the clinical information, the date information, and the temperature information.

15. The system of claim 14, wherein the at least one processor is further configured to execute instructions stored on non-transitory processor readable media, which configure the at least one processor to:
generate an alert associated with temperature information and/or the tracked spreading of the illness; and
transmit the alert over a communication network to at least one computing device.

16. The system of claim 13, wherein at least some of the geographic information, the symptom information, the clinical information and/or the date information is submitted by a user in response to at least one prompt provided on a computing device.

17. The system of claim 12, wherein at least one of the plurality of computing devices is a mobile computing device.

18. The system of claim 12, wherein the at least one processor is further configured to execute instructions stored on non-transitory processor readable media, which configure the at least one processor to:
process the aggregated health data to generate health-related information insights; and
transmit at least one of the health-related information insights over a communication network to at least one computing device.

19. The system of claim 18, wherein the information insights are usable to treat a patient, stop the spread of illness, and/or decrease morbidity or mortality associated with illness.

20. The system of claim 12, wherein the patient information includes contagiousness information representing that a patient is contagious, wherein the contagiousness information is calculated by at least one of the plurality of computing devices using at least one of i) the calculated temperature information and ii) information provided by a user in response to at least one prompt.

21. The system of claim 12, wherein the generated health information is formatted to represent at least one of contagiousness, an illness that is circulating, and at least one symptom that is circulating.

22. The system of claim 21, wherein the formatted generated health information is provided as at least one of historical information, present information and future predictive information.

23. The system of claim 12, wherein the generated health information represents people-to-people relationships and/or people-to-location relationships.

24. The system of claim 12, wherein the at least one processor is further configured to execute instructions stored on non-transitory processor readable media, which configure the at least one processor to:
correlate the aggregated health data with at least one of movement and behavior associated with a population; and
process the correlated aggregated health data to generate the health information.

25. The system of claim 12, wherein the temperature sensing device in connection with the respective at least one computing device is configured to calculate the temperature information using at least one signal received from the temperature sensing device.

26. The system of claim 12, wherein the temperature sensing device in connection with the respective at least one computing device is configured to obtain patient information associated with a user and the calculated temperature information.

27. A health monitoring and tracking method, the method comprising:
calculating temperature information by a plurality of temperature sensing devices, each of the temperature sensing devices communicatively connectable to at least one of a plurality of respective computing devices wherein the temperature information is calculated independently or in connection with the respective at least one computing device;
storing, in at least one data repository, health data from a plurality of the respective computing devices, wherein the health data includes at least calculated temperature information and patient information for a plurality of patients;
aggregating, by at least one processor that is configured to execute instructions stored on non-transitory processor readable media, at least some of the health data stored in the at least one data repository;
processing, by the at least on processor, the aggregated health data to generate health information associated with a plurality of people in a population; and
transmitting, by the at least one processor, the generated health information over a communication network to at least one computing device.

28. The method of claim 27, wherein the patient information includes at least one of:
geographic information representing a location of a respective user;
symptom information representing a symptom of the user associated with an illness or ailment;
clinical information representing at least one characteristic of the user associated with an illness, ailment or temperature;
date information representing a date and/or time associated with at least one of the calculated temperature information, the symptom information, and the clinical information;
patient identification information representing a user or an individual associated with a user;
a device id;
the health information; and
the temperature information.

29. The method of claim 28, further comprising:
tracking, by the at least one processor, spreading of an illness as a function of at least one of the geographic information, the symptom information, the clinical information, the date information, and the temperature information.

30. The method of claim 29, further comprising:
generating, by the at least one processor, an alert associated with temperature information and/or the tracked spreading of the illness; and
transmitting, by the at least one processor, the alert over a communication network to at least one computing device.

31. The method of claim 28, wherein at least some of the geographic information, the symptom information, the clinical information and/or the date information is submitted by a user in response to at least one prompt provided on a computing device.

32. The method of claim 27, wherein at least one of the plurality of computing devices is a mobile computing device.

33. The method of claim 27, further comprising:
processing, by the at least one processor, the aggregated health data to generate health-related information insights; and
transmitting, by the at least one processor, at least one of the health-related information insights over a communication network to at least one computing device.

34. The method of claim 33, wherein the health-related information insights are usable to treat a patient, stop the spread of illness, and/or decrease morbidity or mortality associated with illness.

35. The method of claim 27, wherein the patient information includes contagiousness information representing that a patient is contagious, wherein the contagiousness information is calculated by at least one of the plurality of computing devices using at least one of i) the calculated temperature information and ii) information provided by a user in response to at least one prompt.

36. The method of claim 27, wherein the generated health information is formatted to represent at least one of contagiousness, an illness that is circulating, and at least one symptom that is circulating.

37. The method of claim 36, wherein the formatted generated health information is provided as at least one of historical information, present information and future predictive information.

38. The method of claim 27, wherein the generated health information represents people-to-people relationships and/or people-to-location relationships.

39. The method of claim 27, further comprising:
correlating, by the at least one processor, the aggregated health data with at least one of movement and behavior associated with a population; and
processing, by the at least one processor, the correlated aggregated health data to generate the health information.

40. The method of claim 27, wherein the temperature sensing device in connection with the respective at least one computing device is configured to calculate the temperature information using at least one signal received from the temperature sensing device.

41. The method of claim 27, wherein the temperature sensing device in connection with the respective at least one computing device is configured to obtain patient information associated with a user and the calculated temperature information.
